(19) United States
(12) Patent Application Publication
(10) Pub. No.: US 2025/0370285 A1
(43) Pub. Date: Dec. 4, 2025

(54) OPTICAL DEVICE, OPTICAL TRANSMITTER, AND OPTICAL TRANSCEIVER

(71) Applicant: FUJITSU OPTICAL COMPONENTS LIMITED, Kawasaki-shi (JP)

(72) Inventor: Kento TAKAHASHI, Kawasaki (JP)

(73) Assignee: FUJITSU OPTICAL COMPONENTS LIMITED, Kawasaki-shi (JP)

(21) Appl. No.: 19/057,318

(22) Filed: Feb. 19, 2025

(30) Foreign Application Priority Data
May 31, 2024 (JP) 2024-089492

(51) Int. Cl. G02F 1/035; H04B 10/40; H04B 10/50

(52) U.S. Cl. CPC G02F 1/035; H04B 10/501; G02F 2202/20; H04B 10/40

(57) ABSTRACT

An optical device includes a substrate, an optical waveguide, and a first chip and a second chip each of which is mounted on the substrate, includes a material having an electro-optical effect that is higher than that of the substrate, and includes a crystal axis in which the strongest electro-optical effect is exerted. The first chip includes a first electrode that is arranged in the vicinity of an input side first waveguide, and that applies an electric field flowing in the same direction as an orientation of the crystal axis of the first chip to the input side first waveguide. The second chip includes a second electrode that is arranged in the vicinity of an output side first waveguide, and that applies an electric field flowing in the same direction as an orientation of the crystal axis of the second chip to the output side first waveguide.

### CROSS-REFERENCE TO RELATED APPLICATION

This application is based upon and claims the benefit of priority of the prior Japanese Patent Application No. 2024-089492, filed on May 31, 2024, the entire contents of which are incorporated herein by reference.

### FIELD

The embodiments discussed herein are related to an optical device, an optical transmitter, and an optical transceiver.

### BACKGROUND

For example, an optical device, such as an optical modulator, is constituted such that signal electrodes are arranged on an optical waveguide disposed on an outer surface, and, when a voltage is applied to the signal electrodes, an electric field flowing in the vertical direction with respect to the outer surface of the optical modulator is generated in the interior of the optical waveguide. The refractive index of the optical waveguide is changed due to the electric field, so that the phase of light propagating through the optical waveguide is changed, and it is thus possible to modulate the light. Then, the optical waveguide included in the optical modulator constitutes, for example, a Mach-Zehnder interferometer, and is able to output, for example, an IQ signal that is subjected to XY polarization division multiplexing on the basis of phase differences of the light among a plurality of optical waveguides that are arranged in parallel.

FIG. 10 is a schematic plan diagram illustrating one example of an optical modulator 100 that is conventionally used, and FIG. 11 is a schematic cross-sectional diagram illustrating one example of a cross-sectional part taken along line A-A illustrated in FIG. 10. The optical modulator 100 illustrated in each of FIG. 10 and FIG. 11 includes a substrate 101, a lower part clad 102 that is laminated on the substrate 101, and an electro-optic crystal layer 103 that is laminated on the lower part clad 102, that is formed of a material made of a LN (LiNbO₃), or the like, and that has an electro-optical effect. Furthermore, the optical modulator 100 includes a pair of waveguides 104 that are formed by the electro-optic crystal layer 103, and a pair of ground electrodes 105 that are formed on the electro-optic crystal layer 103. Furthermore, the optical modulator 100 includes a signal electrode 106 that is arranged such that the signal electrode 106 is sandwiched between the pair of ground electrodes 105, and that is formed on the electro-optic crystal layer 103. The pair of ground electrodes 105 and the signal electrode 106 accordingly constitute electrodes having a coplanar structure.

The substrate 101 is a substrate formed of a material made of, for example, Si (Silicon), LN, or the like. The lower part clad 102 is a layer made of, for example, SiO₂ that has a lower optical refractive index than LN. The electro-optic crystal layer 103 is a thin film substrate that strongly confines light and that is advantageous in terms of reducing its size.

Since the optical waveguide 104 is formed by the electro-optic crystal layer 103, the optical waveguide 104 is superior in terms of, for example, an insertion loss and transmission characteristics. Since the electro-optic crystal layer 103 is an X-cut substrate, a chirp free operation is possible as a result of a structural symmetry, and thus the electro-optic crystal layer 103 is suitable for long distance transmission. The optical waveguide 104 includes one of a waveguide 104A, the other of a waveguide 104B, a first coupler 104C, and a second coupler 104D. The first coupler 104C is a coupler that is connected to an input waveguide, that splits the signal light received from the input waveguide into the one waveguide 104A and the other waveguide 104B, and that outputs the split light. The second coupler 104D is a coupler that is connected to the output waveguide, that multiplexes the signal light received from the one waveguide 104A and the signal light received from the other waveguide 104B, and that outputs the multiplexed light.

The ground electrode 105 includes one of a ground electrode 105A, the other of a ground electrode 105B. The one waveguide 104A is arranged between the one ground electrode 105A and the signal electrode 106. Furthermore, the other waveguide 104B is arranged between the other ground electrode 105B and the signal electrode 106.

The orientation of a crystal axis Z11 of the electro-optic crystal layer 103 is a width direction (Z direction) that is orthogonal to the traveling direction (Y direction) of the light. In the one waveguide 104A, an optical refractive index is changed in accordance with an electric field flowing in an electric field direction all from the signal electrode 106 to the one ground electrode 105A. Furthermore, in the other waveguide 104B, an optical refractive index is changed in accordance with an electric field flowing in an electric field direction b11 from the signal electrode 106 to the other ground electrode 105B.

The modulation efficiency of the optical modulator 100 is greatly affected by a length of an interaction section included in each of the one waveguide 104A and the other waveguide 104B to which an electric field is applied, and thus, in order to reduce the size of the optical modulator 100 while keeping the modulation efficiency, the optical modulator 100 needs to have a structure in which the interaction sections are folded.

FIG. 12 is a schematic plan diagram illustrating one example of a configuration of an optical modulator 100A that is conventionally used, and FIG. 13 is a schematic cross-sectional diagram illustrating one example of a cross-sectional part taken along line A-A illustrated in FIG. 12. The optical modulator 100A illustrated in FIG. 12 includes an outward path side interaction section 110A, a return path side interaction section 110B, and a folded waveguide 130 that optically connects a pair of waveguides 114 arranged inside of the outward path side interaction section 110A and the pair of waveguides 114 arranged inside of the return path side interaction section 110B.

The optical modulator 100A includes a substrate 111, a lower part clad 112 that is laminated on the substrate 111, and an electro-optic crystal layer 113 that is laminated on the lower part clad 112 and that is made of an LN material or the like having an electro-optical effect. Furthermore, the optical modulator 100A includes the pair of waveguides 114 formed by the electro-optic crystal layer 113. The optical modulator 100A includes a pair of ground electrodes 115 that is formed on the electro-optic crystal layer 113, and a signal electrode 116 that is arranged such that the signal electrode 116 are sandwiched between the pair of ground electrodes 115, and that is formed on the electro-optic crystal layer 113.

The substrate 111 is a substrate formed of a material made of, for example, Si (Silicon), LN, or the like. The lower part clad 112 is a layer that has a lower optical refractive index than the LN, and that is made of, for example, SiO₂. The electro-optic crystal layer 113 is a thin film substrate that strongly confines light and that is advantageous in terms of reducing its size.

Since the optical waveguide 114 is formed by the electro-optic crystal layer 113, the optical waveguide 114 is superior in terms of, for example, an insertion loss and transmission characteristics. Since the electro-optic crystal layer 113 is an X-cut substrate, a chirp free operation is possible as a result of a structural symmetry, and thus the electro-optic crystal layer 113 is suitable for long distance transmission. The optical waveguide 114 includes an outward path side eleventh waveguide 114A1, an outward path side twelfth waveguide 114B1, a return path side eleventh waveguide 114A2, and a return path side twelfth waveguide 114B2. Furthermore, the optical waveguide 114 includes a first coupler 114C and a second coupler 114D. The first coupler 114C is a coupler that is connected to the input waveguide, that splits the signal light received from the input waveguide into the outward path side eleventh waveguide 114A1 and the outward path side twelfth waveguide 114B1, and that outputs the split light. The second coupler 114D is a coupler that is connected to the output waveguide, that multiplexes the signal light received from the return path side eleventh waveguide 114A2 and the return path side twelfth waveguide 114B2, and that outputs the multiplexed light.

The outward path side interaction section 110A includes the outward path side eleventh waveguide 114A1, the outward path side twelfth waveguide 114B1, an outward path side ground electrode 115A, an outward path side signal electrode 116A, and a common ground electrode 115C. The outward path side ground electrode 115A is a ground electrode that is arranged in parallel with the outward path side eleventh waveguide 114A1. The common ground electrode 115C is a ground electrode that is arranged in parallel with the outward path side twelfth waveguide 114B1. The outward path side signal electrode 116A is a signal electrode that is arranged in parallel with a portion between the outward path side eleventh waveguide 114A1 and the outward path side twelfth waveguide 114B1.

The return path side interaction section 110B includes the return path side eleventh waveguide 114A2, the return path side twelfth waveguide 114B2, a return path side ground electrode 115B, and a return path side signal electrode 116B. The return path side ground electrode 115B is a ground electrode that is arranged in parallel with the arranged on the return path side eleventh waveguide 114A2. The common ground electrode 115C is a ground electrode that is arranged in parallel with the return path side twelfth waveguide 114B2. The return path side signal electrode 116B is a signal electrode that is arranged in parallel with a portion between the return path side eleventh waveguide 114A2 and the return path side twelfth waveguide 114B2. The signal electrode 116 includes a folded signal electrode 116C that electrically connects a portion between the outward path side signal electrode 116A and the return path side signal electrode 116B. The ground electrode 115 includes a folded ground electrode 115D that electrically connects a portion between the outward path side ground electrode 115A and the return path side ground electrode 115B.

The one waveguide 114 includes the outward path side eleventh waveguide 114A1 and the return path side eleventh waveguide 114A2, and optically connects a portion between the outward path side eleventh waveguide 114A1 and the return path side eleventh waveguide 114A2 by using one of a folded waveguide 130A. The other waveguide 114 includes the outward path side twelfth waveguide 114B1 and the return path side twelfth waveguide 114B2, and optically connects a portion between the outward path side twelfth waveguide 114B1 and the return path side twelfth waveguide 114B2 by using the other folded waveguide 130B.

The orientation of a crystal axis Z21 of the electro-optic crystal layer 113 is a width direction (Z direction) that is orthogonal to the traveling direction (Y direction) of light. In the outward path side eleventh waveguide 114A1, an optical refractive index is changed in accordance with an electric field flowing in an electric field direction a21 from the outward path side signal electrode 116A to the outward path side ground electrode 115A. Furthermore, in the outward path side twelfth waveguide 114B1, an optical refractive index is changed in accordance with an electric field flowing in an electric field direction b21 from the outward path side signal electrode 116A to the common ground electrode 115C.

In the return path side eleventh waveguide 114A2, an optical refractive index is changed in accordance with an electric field flowing in an electric field direction a22 from the return path side signal electrode 116B to the return path side ground electrode 115B. Furthermore, in the return path side twelfth waveguide 114B2, an optical refractive index is changed in accordance with an electric field flowing in an electric field direction b22 from the return path side signal electrode 116B to the common ground electrode 115C.
Patent Document 1: U.S. Patent Application Publication No. 2023/0107837
Patent Document 2: Japanese Laid-open Patent Publication No. 2022-73196

However, in the optical modulator 100A having the folded structure, the electric field direction a21 of an electric field flowing from the outward path side eleventh waveguide 114A1 is the same as the crystal direction (Z1 direction) of an LN crystal, but, in contrast, the electric field direction a22 an electric field flowing from the return path side eleventh waveguide 114A2 is different from the crystal direction (Z1 direction) of the LN crystal. In other words, the electric field direction a21 of an electric field flowing from the outward path side eleventh waveguide 114A1 is the direction opposite to the electric field direction a22 of an electric field flowing from the return path side eleventh waveguide 114A2. Therefore, the electric field flowing from the outward path side eleventh waveguide 114A1 in the electric field direction a21 is canceled out by the electric field flowing from the return path side eleventh waveguide 114A2 in the electric field direction a22, so that the modulation efficiency consequently decreases.

Similarly, the electric field direction b21 of an electric field flowing from the outward path side twelfth waveguide 114B1 is the same as the crystal direction (Z1 direction) of the LN crystal, but, in contrast, the electric field direction b22 of an electric field flowing from the return path side twelfth waveguide 114B2 is different from the crystal direction (Z1 direction) of the LN crystal. In other words, the electric field direction b21 of an electric field flowing from the outward path side twelfth waveguide 114B1 is the direction opposite to the electric field direction b22 of an electric field flowing from the return path side twelfth waveguide 114B2. Therefore, the electric field flowing from the outward path side twelfth waveguide 114B1 in the electric field direction b21 is canceled out by the electric field flowing from the return path side twelfth waveguide 114B2 in the electric field direction b22, so that the modulation efficiency consequently decreases.

In the optical modulator 100A that is an X-cut LN modulator operated by single ended drive using a single piece of a signal electrode, the crystal axis is accordingly inverted with respect to the traveling direction (Y direction) of light between the outward path and the return path. As a result of this, a phase change in the inverse direction is generated, the phase change in the outward path is canceled out by the phase change in the return path, so that the modulation efficiency consequently decreases.

Furthermore, it is conceivable to use a method of replacing the right and left positional relationship of the optical waveguides between the outward path and the return path with respect to the traveling direction of the light. However, the structure of reflection provided by a cross waveguide and an external mirror used to replacing the optical waveguides causes reflection, attenuation, and the like of an optical signal.

Furthermore, it is also conceivable to use a method of replacing the right and left positional relationship of the signal electrode and the ground electrodes between the outward path and the return path with respect to the traveling direction. However, there is a need to greatly change the design of the signal electrodes between the outward path and the return path, and therefore, it is conceivable occurrence of reflection of a signal, a mismatch in velocity between electricity and light, and the like.

### SUMMARY

According to an aspect of an embodiment, an optical device includes a substrate, an optical waveguide that is provided on the substrate, and a first chip and a second chip each of which is mounted on the substrate, includes a material having an electro-optical effect that is higher than that of the substrate, and includes a crystal axis in which the strongest electro-optical effect is exerted. The optical waveguide includes a first coupler, an input side first waveguide and an input side second waveguide that are connected to the first coupler, a second coupler, an output side first waveguide and an output side second waveguide that are connected to the second coupler, a first bent waveguide that connects a portion between the input side first waveguide and the output side first waveguide, and a second bent waveguide that connects a portion between the input side second waveguide and the output side second waveguide. The first chip includes a first electrode that is arranged in the vicinity of the input side first waveguide, and that applies an electric field flowing in the same direction as an orientation of the crystal axis of the first chip to the input side first waveguide. The second chip includes a second electrode that is arranged in the vicinity of the output side first waveguide, and that applies an electric field flowing in the same direction as an orientation of the crystal axis of the second chip to the output side first waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan diagram illustrating one example of an optical modulator according to a first embodiment;

FIG. 2A is a schematic cross-sectional diagram illustrating one example of a cross-sectional part taken along line A-A illustrated in FIG. 1;

FIG. 2B is a schematic cross-sectional diagram illustrating one example of a cross-sectional part taken along line B-B illustrated in FIG. 1;

FIG. 3A is a schematic cross-sectional diagram illustrating one example of a cross-sectional part taken along line C-C illustrated in FIG. 1;

FIG. 3B is a schematic cross-sectional diagram illustrating one example of a cross-sectional part taken along line D-D illustrated in FIG. 1;

FIG. 4 is a schematic cross-sectional diagram illustrating one example of a cross-sectional part taken along line E-E illustrated in FIG. 1;

FIG. 5 is a schematic plan diagram illustrating one example of an optical modulator according to a second embodiment;

FIG. 6A is a schematic cross-sectional diagram illustrating one example of a cross-sectional part taken along line A-A illustrated in FIG. 5;

FIG. 6B is a schematic cross-sectional diagram illustrating one example of a cross-sectional part taken along line B-B illustrated in FIG. 5;

FIG. 6C is a schematic cross-sectional diagram illustrating one example of a cross-sectional part taken along line C-C illustrated in FIG. 5;

FIG. 7A is a schematic cross-sectional diagram illustrating one example of a cross-sectional part taken along line D-D illustrated in FIG. 5;

FIG. 7B is a schematic cross-sectional diagram illustrating one example of a cross-sectional part taken along line E-E illustrated in FIG. 5;

FIG. 8 is a schematic cross-sectional diagram illustrating one example of a cross-sectional part taken along line F-F illustrated in FIG. 5;

FIG. 9 is an explanation diagram illustrating one example of an optical transceiver according to the present embodiment;

FIG. 10 is a schematic plan diagram illustrating one example of an optical modulator that is conventionally used;

FIG. 11 is a schematic cross-sectional diagram illustrating one example of a cross-sectional part taken along line A-A illustrated in FIG. 10;

FIG. 12 is a schematic plan diagram illustrating one example of an optical modulator that is conventionally used; and

FIG. 13 is a schematic cross-sectional diagram illustrating one example of a cross-sectional part taken along line A-A illustrated in FIG. 12.

### DESCRIPTION OF EMBODIMENTS

Preferred embodiments of the present invention will be explained with reference to accompanying drawings. Furthermore, the present invention is not limited to the embodiments.

### (a) First Embodiment

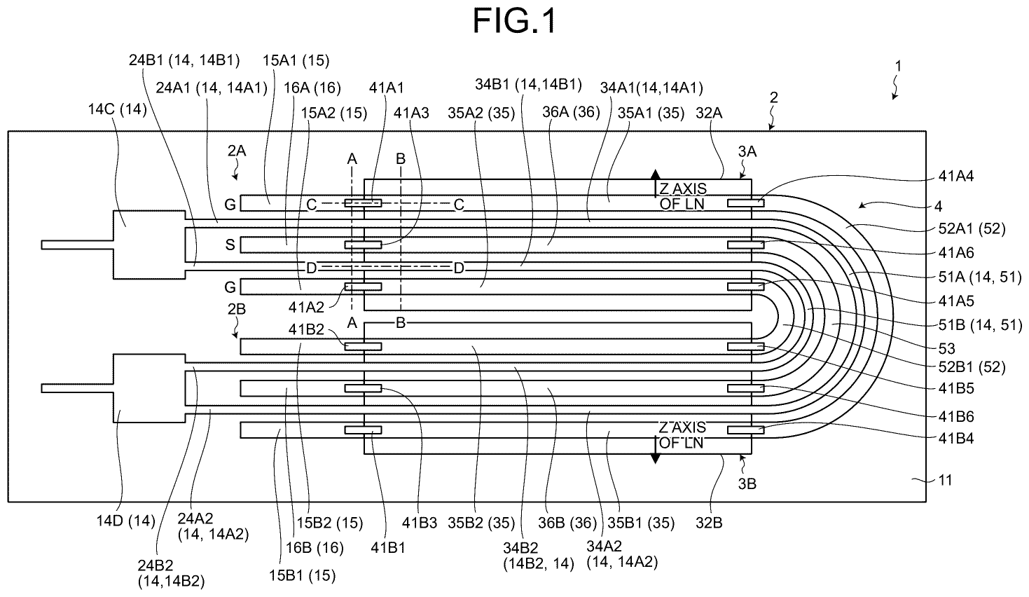

FIG. 1 is a schematic plan diagram illustrating one example of an optical modulator 1 according to a first embodiment. The optical modulator 1 illustrated in FIG. 1 includes a chip 2, and a first chip 3A and a second chip 3B that are mounted on the chip 2. The chip 2, that is, for example, a silicon photonics (SiPh) chip 2, includes an outward path section 2A, a return path section 2B, and a folded portion 4 that optically connects a portion between the outward path section 2A and the return path section 2B via the first chip 3A and the second chip 3B.

The chip 2 includes a substrate 11 made of, for example, Si or the like, an optical waveguide 14 that is provided on the substrate 11, a pair of ground electrodes 15, and a signal electrode 16 that is arranged so as to be sandwiched between the pair of ground electrodes 15. A case of a Si substrate will be described as an example of the substrate 11, but, the substrate 11 may be formed of material made of at least one of, for example, SiO₂ (silicon dioxide), TiO₂ (titanium dioxide), Qtz, and sapphire, and appropriate modifications are possible. The pair of ground electrodes 15 and the signal electrode 16 accordingly constitute GSG electrodes having a coplanar structure made of, for example, aluminum (Al), or the like.

The outward path section 2A includes an outward path side first waveguide 14A1, an outward path side second waveguide 14B1, a pair of first ground electrodes 15A, and a first signal electrode 16A. Each of the outward path side first waveguide 14A1 and the outward path side second waveguide 14B1 is a waveguide made of, for example, Si, or the like. Moreover, each of the outward path side first waveguide 14A1 and the outward path side second waveguide 14B1 is not limited to the Si waveguide, but may be formed of a material made of, for example, SiN, LN, or the like, and appropriate modifications are possible. The first ground electrode 15A and the first signal electrode 16A are, for example, Au electrodes. Moreover, the first ground electrode 15A and the first signal electrode 16A are not limited to the Au electrodes, but may be made of, for example, Al, Cu, or the like, and appropriate modifications are possible.

The first ground electrode 15A includes one of a first ground electrode 15A1 and the other of a first ground electrode 15A2. The first ground electrode 15A1 is a ground electrode that is arranged in parallel with the outward path side first waveguide 14A1. The first ground electrode 15A2 is a ground electrode that is arranged in parallel with the outward path side second waveguide 14B1. The first signal electrode 16A is a signal electrode that is arranged in parallel with a portion between the outward path side first waveguide 14A1 and the outward path side second waveguide 14B1.

The return path section 2B includes a return path side first waveguide 14A2, a return path side second waveguide 14B2, a pair of second ground electrodes 15B, and a second signal electrode 16B. Each of the return path side first waveguide 14A2 and the return path side second waveguide 14B2 is an optical waveguide made of, for example, Si, or the like. Moreover, the return path side first waveguide 14A2 and the return path side second waveguide 14B2 are not limited to the Si waveguides, but may be formed of a material made of, for example, SiN, LN, or the like, and appropriate modifications are possible. The second ground electrode 15B and the second signal electrode 16B are, for example, Au electrodes. Moreover, the second ground electrode 15B and the second signal electrode 16B are not limited to the Au electrodes, but may be made of, for example, Al, Cu, or the like, and appropriate modifications are possible.

The second ground electrode 15B includes one of a second ground electrode 15B1 and the other of a second ground electrode 15B2. The second ground electrode 15B1 is a ground electrode that is arranged in parallel with the return path side first waveguide 14A2. The second ground electrode 15B2 is a ground electrode that is arranged in parallel with the return path side second waveguide 14B2. The second signal electrode 16B is a signal electrode that is arranged in parallel with a portion between the return path side first waveguide 14A2 and the return path side second waveguide 14B2.

The optical waveguide 14 includes a first coupler 14C, and also includes the outward path side first waveguide 14A1 and the outward path side second waveguide 14B1 that are connected to the first coupler 14C. Furthermore, the optical waveguide 14 includes a second coupler 14D, and also includes the return path side first waveguide 14A2 and the return path side second waveguide 14B2 that are connected to the second coupler 14D. The first coupler 14C is a coupler that is connected to an input waveguide, that splits the signal light received from the input waveguide into the outward path side first waveguide 14A1 and the outward path side second waveguide 14B1, and that outputs the split light. The second coupler 14D is a coupler that is connected to the output waveguide, that multiplexes the signal light received from each of the return path side first waveguide 14A2 and the return path side second waveguide 14B2, and outputs the multiplexed light.

The folded portion 4 includes a folded waveguide 51 and a folded electrode 52. The folded waveguide 51 includes a first folded waveguide 51A that optically connects a portion between the outward path side first waveguide 14A1 and the return path side first waveguide 14A2, and a second folded waveguide 51B that optically connects a portion between the outward path side second waveguide 14B1 and the return path side second waveguide 14B2. The first folded waveguide 51A is a waveguide in which the traveling direction of the light passing through the outward path side first waveguide 14A1 and the traveling direction of the light passing through the return path side first waveguide 14A2 change 180 degrees. The second folded waveguide 51B is a waveguide in which the traveling direction of the light passing through the outward path side second waveguide 14B1 and the traveling direction of the light passing through the return path side second waveguide 14B2 change 180 degrees. Moreover, for convenience of description, as an example, the folded portion 4 is constituted to have the folded structure in which the traveling directions of the two pieces of light change 180 degrees, but any structure may be used as long as a structure in which the traveling directions of the two pieces of light change by a degree equal to or larger than 90 degrees, and appropriate modifications are possible.

The folded electrode 52 includes a first folded ground electrode 52A1, a second folded ground electrode 52B1, and a folded signal electrode 53. The first folded ground electrode 52A1 is a ground electrode that is arranged in parallel with the first folded waveguide 51A. The second folded ground electrode 52B1 is a ground electrode that is arranged in parallel with the second folded waveguide 51B. The folded signal electrode 53 is a signal electrode that is arranged in parallel with a portion between the first folded waveguide 51A and the second folded waveguide 51B.

Each of the first chip 3A and the second chip 3B is a chip that is mounted on the substrate 11, that includes, for example, LN (LiNbO₃) as a material having an electro-optical effect that is higher than that of the substrate 11, and that has a crystal axis in which the strongest electro-optical effect is exerted. Moreover, as the material having the electro-optical effect, any material may be used as long as, for example, γ 33 is equal to or greater than 25 pm/V, and appropriate modifications are possible. Each of the first chip 3A and the second chip 3B is formed of, for example, an X-cut thin film LN. Each of the first chip 3A and the second chip 3B is accordingly mounted on the substrate 11 by using a thin film transfer technology, that is, for example, a micro transfer printing (μ-TP) technology. The width of the substrate, on which the first chip 3A and the second chip 3B are mounted, in the planar direction and the width of the substrate in the vertical direction with respect to each of the electrode lines are equal to or less than, for example, 300 μm in a case where the μ-TP technology is used.

The first chip 3A is mounted on the substrate 11 such that an orientation of Z1 of the crystal axis of the first chip 3A is orthogonal to the traveling direction of light passing through each of the outward path side first waveguide 14A1 and the outward path side second waveguide 14B1. The first chip 3A includes a first electrode that is arranged in the vicinity of an outward path side fifth waveguide 34A1 included in the outward path side first waveguide 14A1, and that applies an electric field flowing in the same direction as the orientation Z1 of the crystal axis of the first chip 3A to the outward path side fifth waveguide 34A1. The first chip 3A includes the first electrode that is arranged in the vicinity of an outward path side sixth waveguide 34B1 included in the outward path side second waveguide 14B1, and that applies an electric field flowing in the inverse direction with respect to the orientation of Z1 the crystal axis of the first chip 3A to the outward path side sixth waveguide 34B1.

The second chip 3B is mounted on the substrate 11 such that an orientation of Z2 the crystal axis of the second chip 3B is orthogonal to the traveling direction of light passing through each of the return path side first waveguide 14A2 and the return path side second waveguide 14B2. The second chip 3B includes a second electrode that is arranged in the vicinity of a return path side fifth waveguide 34A2 included in the return path side first waveguide 14A2, and that applies an electric field flowing in the same direction as the orientation of Z2 the crystal axis of the second chip 3B to the return path side fifth waveguide 34A2. The second chip 3B includes a second electrode that is arranged in the vicinity of a return path side sixth waveguide 34B2 included in the return path side second waveguide 14B2, and that applies an electric field flowing in the inverse direction with respect to the orientation of Z2 of the crystal axis of the second chip 3B to the return path side sixth waveguide 34B2. In other words, each of the first chip 3A and the second chip 3B is mounted on the substrate 11 such that the Z-axis direction is not shared each other.

The outward path side first waveguide 14A1 includes an outward path side third waveguide 24A1 and the outward path side fifth waveguide 34A1 that are arranged on the substrate 11 on which the chip 2 is mounted. The return path side first waveguide 14A2 includes a return path side third waveguide 24A2 and the return path side fifth waveguide 34A2 that are arranged on the substrate 11 on which the chip 2 is mounted.

Each of the first chip 3A and the second chip 3B is mounted on the substrate 11 on which the chip 2 is mounted such that the orientation of Z1 of the crystal axis of the first chip 3A is 180 degrees different from the orientation of Z2 of the crystal axis of the second chip 3B. Furthermore, each of the first chip 3A and the second chip 3B is mounted on the substrate 11 such that an orientation of a1 of the electric field applied from the first electrode to the outward path side fifth waveguide 34A1 is 180 degrees different from an orientation of a2 of the electric field applied from the second electrode to the return path side fifth waveguide 34A2.

The first electrode included in the first chip 3A is an electrode that is constituted to have a GSG coplanar structure and that includes a first signal electrode 36A(36), one of a first ground electrode 35A1(35), and the other of a first ground electrode 35A2 (35). The first signal electrode 36A is arranged in parallel at a portion between the outward path side fifth waveguide 34A1 and the outward path side sixth waveguide 34B1. The first ground electrode 35A1 is arranged in parallel with the outward path side fifth waveguide 34A1. The first ground electrode 35A2 is arranged in parallel with the outward path side sixth waveguide 34B1.

The second electrode included in the second chip 3B is an electrode that is constituted to have a GSG coplanar structure and that includes a second signal electrode 36B(36), one of a second ground electrode 35B1(35), and the other of a second ground electrode 35B2(35). The second signal electrode 36B is arranged in parallel at a portion between the return path side fifth waveguide 34A2 and the return path side sixth waveguide 34B2. The second ground electrode 35B1 is arranged in parallel with the return path side fifth waveguide 34A2. The second ground electrode 35B2 is arranged in parallel with the return path side sixth waveguide 34B2.

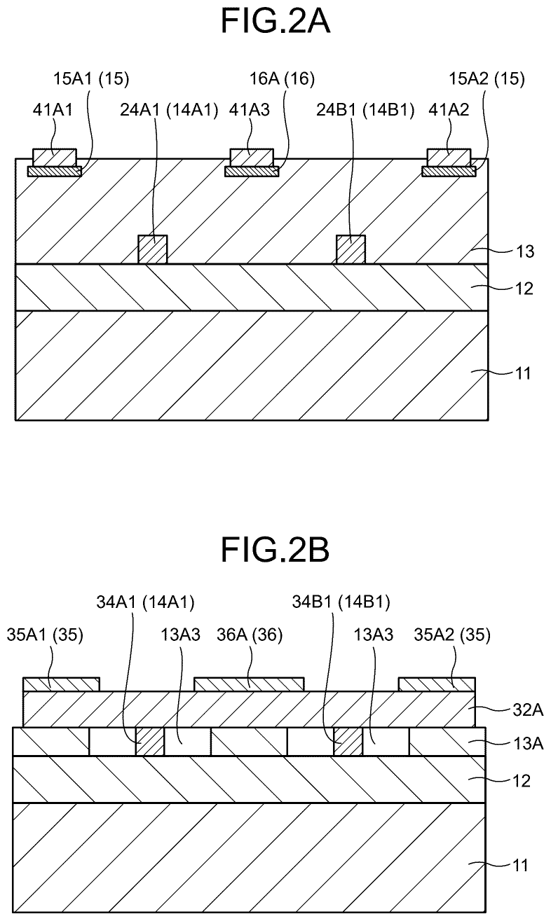

FIG. 2A is a schematic cross-sectional diagram illustrating one example of a cross-sectional part taken along line A-A illustrated in FIG. 1. The cross-sectional part taken along line A-A is a cross-sectional part of an outward path side fourth waveguide 24B1 and the outward path side third waveguide 24A1 that are included in the chip 2. The optical modulator 1 illustrated in FIG. 2A includes the substrate 11, a lower part clad 12 that is laminated on the substrate 11, the outward path side third waveguide 24A1 that is laminated on the lower part clad 12, and the outward path side fourth waveguide 24B1 that is laminated on the lower part clad 12. Furthermore, the optical modulator 1 includes the lower part clad 12, an upper part clad 13 that is formed on both of the outward path side third waveguide 24A1 and the outward path side fourth waveguide 24B1, and the first electrode that is formed on the upper part clad 13. Moreover, the lower part clad 12 and the upper part clad 13 are made of, for example, SiO₂, or the like.

The first electrode included in the chip 2 is an electrode that has a coplanar structure, and that includes the first signal electrode 16A, the one first ground electrode 15A1, and the other first ground electrode 15A2. The first signal electrode 16A is arranged in parallel with a portion between the outward path side third waveguide 24A1 and the outward path side fourth waveguide 24B1. The first ground electrode 15A1 is arranged in parallel with the outward path side third waveguide 24A1. The first ground electrode 15A2 is arranged in parallel with the outward path side fourth waveguide 24B1.

The first electrode includes a connecting portion 41A3 that electrically connects a portion between the first signal electrode 16A included in the chip 2 and the first signal electrode 36A included in the first chip 3A. The first electrode includes a connecting portion 41A1 that electrically connects a portion between the first ground electrode 15A1 included in the chip 2 and the first ground electrode 35A1 included in the first chip 3A. The first electrode includes a connecting portion 41A2 that electrically connects a portion between the first ground electrode 15A2 included in the chip 2 and the first ground electrode 35A2 included in the first chip 3A. The first electrode includes a connecting portion 41A6 that electrically connects a portion between the first signal electrode 36A and the folded signal electrode 53. The first electrode includes a connecting portion 41A4 that electrically connects a portion between the first ground electrode 35A1 and the first folded ground electrode 52A1. The first electrode includes a connecting portion 41A5 that electrically connects a portion between the first ground electrode 35A2 and the second folded ground electrode 52B1.

Moreover, in FIG. 2A, the description has been given by focusing on the region of the first electrode included in the chip 2, and the same applies to the region of the second electrode included in the chip 2. The optical modulator 1 includes the return path side third waveguide 24A2 that is laminated on the lower part clad 12, and a return path side fourth waveguide 24B2 that is laminated on the lower part clad 12. Furthermore, the optical modulator 1 includes the lower part clad 12, the upper part clad 13 that is formed on both of the return path side third waveguide 24A2 and the return path side fourth waveguide 24B2, and the second electrode that is formed on the upper part clad 13.

The second electrode included in the chip 2 is an electrode that has a coplanar structure, and that includes the second signal electrode 16B, the one second ground electrode 15B1, and the other second ground electrode 15B2. The second signal electrode 16B is arranged in parallel with a portion between the return path side third waveguide 24A2 and the return path side fourth waveguide 24B2. The second ground electrode 15B1 is arranged in parallel with the return path side third waveguide 24A2. The second ground electrode 15B2 is arranged in parallel with the return path side fourth waveguide 24B2.

The second electrode includes a connecting portion 41B3 that electrically connects a portion between the second signal electrode 16B included in the chip 2 and the second signal electrode 36B included in the second chip 3B. The second electrode includes a connecting portion 41B1 that electrically connects a portion between the second ground electrode 15B1 included in the chip 2 and the second ground electrode 35B1 included in the second chip 3B. The second electrode includes a connecting portion 41B2 that electrically connects a portion between the second ground electrode 15B2 included in the chip 2 and the second ground electrode 35B2 included in the second chip 3B. The second electrode includes a connecting portion 41B6 that electrically connects a portion between the second signal electrode 36B and the folded signal electrode 53. The second electrode includes a connecting portion 41B4 that electrically connects a portion between the second ground electrode 35B1 and the first folded ground electrode 52A1. The second electrode includes a connecting portion 41B5 that electrically connects a portion between the second ground electrode 35B2 and the second folded ground electrode 52B1.

FIG. 2B is a schematic cross-sectional diagram illustrating one example of a cross-sectional part taken along line B-B illustrated in FIG. 1. The cross-sectional part taken along line B-B is a cross-sectional part the outward path side fifth waveguide 34A1 and the outward path side sixth waveguide 34B1 on which the first chip 3A is mounted. The optical modulator 1 illustrated in FIG. 2B includes the substrate 11, the lower part clad 12 that is laminated on the substrate 11, an upper part clad 13A that is laminated on the lower part clad 12, and the first chip 3A that is mounted on the upper part clad 13A. Moreover, the upper part clad 13A is a clad layer formed such that the upper part clad 13 illustrated in FIG. 2A is etched or the like.

The first chip 3A is arranged at an opening portion 13A3 formed in the upper part clad 13A, and, is also arranged in the vicinity of the outward path side fifth waveguide 34A1 on the lower part clad 12 and the outward path side sixth waveguide 34B1 that are arranged on the lower part clad 12. Furthermore, the first chip 3A includes an electro-optic crystal layer 32A that is mounted on the upper part clad 13A, and also includes the first electrode that includes the first signal electrode 36A, the first ground electrode 35A1, and the first ground electrode 35A2 and that is formed on the electro-optic crystal layer 32A.

Moreover, in FIG. 2B, the description has been given by focusing on the first chip 3A, and the same applies to the second chip 3B. The optical modulator 1 includes the second chip 3B the is mounted on the upper part clad 13A.

The second chip 3B is arranged at the opening portion 13A3 formed in the upper part clad 13A, and, is also arranged in the vicinity of the return path side fifth waveguide 34A2 and the return path side sixth waveguide 34B2 that are arranged on the lower part clad 12. Furthermore, the second chip 3B includes an electro-optic crystal layer 32B that is mounted on the upper part clad 13A, and also includes the second electrode that includes the second signal electrode 36B, the second ground electrode 35B1, and the second ground electrode 35B2, and that is formed on the electro-optic crystal layer 32B.

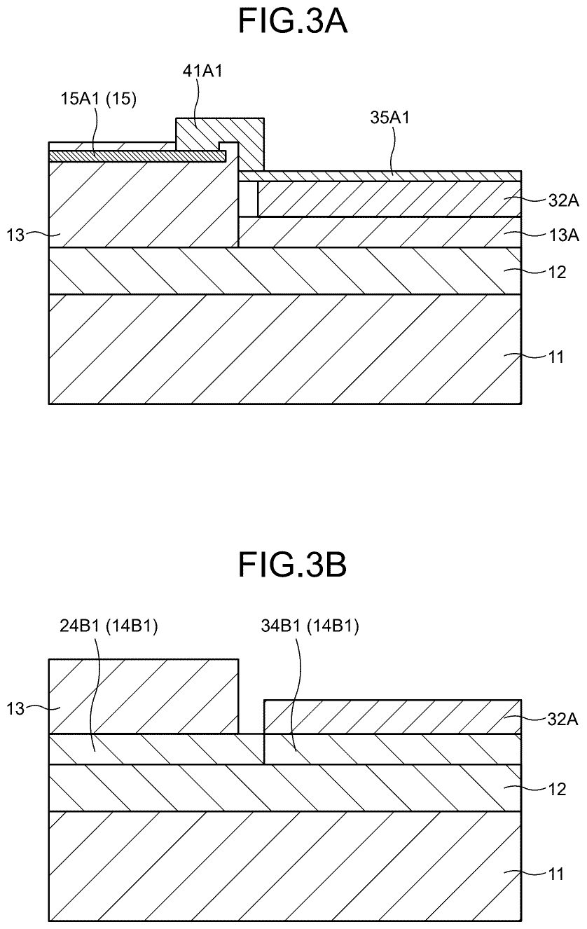

FIG. 3A is a schematic cross-sectional diagram illustrating one example of a cross-sectional part taken along line C-C illustrated in FIG. 1. The cross-sectional part taken along line C-C is a cross-sectional part of the optical modulator 1 that electrically connects a portion between the first ground electrode 15A1 included in the chip 2 and the first ground electrode 35A1 included in the first chip 3A. The optical modulator 1 illustrated in FIG. 3A includes the upper part clad 13 that is laminated on the lower part clad 12, the upper part clad 13A that is laminated on the lower part clad 12, and the first ground electrode 15A1 that is arranged on the upper part clad 13. The optical modulator 1 includes the electro-optic crystal layer 32A that is included in the first chip 3A and that is mounted on the upper part clad 13A, and the first ground electrode 35A1 that is arranged on the electro-optic crystal layer 32A. The optical modulator 1 electrically connects a portion between the first ground electrode 15A1 that is arranged in the upper part clad 13 that is included in the chip 2 and the first ground electrode 35A1 that is arranged on the electro-optic crystal layer 32A that is included in the first chip 3A by using the connecting portion 41A1.

Moreover, in FIG. 3A, the description has been given by focusing on the first chip 3A, and the same applies to the second chip 3B. The optical modulator 1 includes the upper part clad 13 and the upper part clad 13A that are laminated on the lower part clad 12, and includes the second ground electrode 15B1 that is arranged in the upper part clad 13. The optical modulator 1 includes the electro-optic crystal layer 32B formed in the second chip 3B that is mounted on the upper part clad 13A, and the second ground electrode 35B1 that is arranged on the electro-optic crystal layer 32B. The optical modulator 1 electrically connects a portion between the second ground electrode 15B1 that is arranged in the upper part clad 13 included in the chip 2 and the second ground electrode 35B1 that is arranged on the electro-optic crystal layer 32B included in the second chip 3B by using the connecting portion 41B1.

FIG. 3B is a schematic cross-sectional diagram illustrating one example of a cross-sectional part taken along line D-D illustrated in FIG. 1. The cross-sectional part taken along line D-D is a cross-sectional part of the optical modulator 1 that optically connects a portion between the outward path side fourth waveguide 24B1 included in the chip 2 and the outward path side sixth waveguide 34B1 on which the first chip 3A is mounted. The optical modulator 1 illustrated in FIG. 3B includes the outward path side fourth waveguide 24B1 and the outward path side sixth waveguide 34B1 that are arranged on the lower part clad 12, and also includes the upper part clad 13 that covers the outward path side fourth waveguide 24B1. Furthermore, the optical modulator 1 includes the electro-optic crystal layer 32A that is arranged on the outward path side sixth waveguide 34B1.

Moreover, in FIG. 3B, the description has been given by focusing on the first chip 3A, and the same applies to the second chip 3B. The optical modulator 1 includes the return path side fourth waveguide 24B2 and the return path side sixth waveguide 34B2 that are arranged on the lower part clad 12, the upper part clad 13 that covers the return path side fourth waveguide 24B2, and the electro-optic crystal layer 32B that is arranged on the return path side sixth waveguide 34B2.

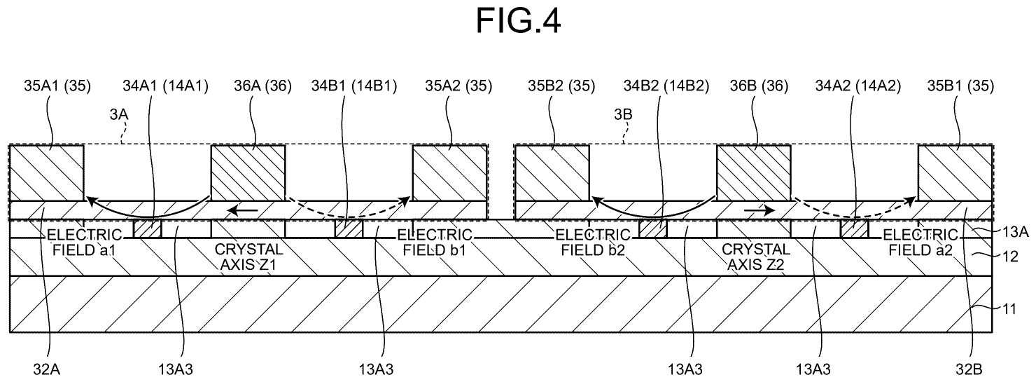

FIG. 4 is a schematic cross-sectional diagram illustrating one example of a cross-sectional part taken along line E-E illustrated in FIG. 1. The orientation of Z1 of the crystal axis of the electro-optic crystal layer 32A formed in the first chip 3A is a width direction (Z direction) that is orthogonal to the traveling direction (Y direction) of light. In the outward path side fifth waveguide 34A1 on which the first chip 3A is mounted, an optical refractive index is changed in accordance with an electric field flowing in the electric field direction a1 from the first signal electrode 36A to the first ground electrode 35A1. Furthermore, in the outward path side sixth waveguide 34B1 on which the first chip 3A is mounted, an optical refractive index is changed in accordance with an electric field flowing in the electric field direction b1 from the first signal electrode 36A to the first ground electrode 35A2.

the orientation of Z2 of the crystal axis of the electro-optic crystal layer 32B formed in the second chip 3B is a width direction (Z direction) that is orthogonal to the traveling direction (Y direction) of light. the orientation of Z1 of the crystal axis of the electro-optic crystal layer 32A formed in the first chip 3A is 180 degrees different from the orientation of Z2 of the crystal axis of the electro-optic crystal layer 32B formed in the second chip 3B. In the return path side fifth waveguide 34A2 on which the second chip 3B is mounted, an optical refractive index is changed in accordance with an electric field flowing in the electric field direction a2 from the second signal electrode 36B to the second ground electrode 35B1. Furthermore, in the return path side sixth waveguide 34B2 on which the second chip 3B is mounted, an optical refractive index is changed in accordance with an electric field flowing in the electric field direction b2 from the second signal electrode 36B to the second ground electrode 35B2.

The electric field direction a1 of the outward path side fifth waveguide 34A1 on which the first chip 3A is mounted is the same as the crystal direction (Z1 direction) of the electro-optic crystal layer 32A formed in the first chip 3A. The electric field direction a2 of the return path side fifth waveguide 34A2 on which the second chip 3B is mounted is the same as the crystal direction (Z2 direction) of the electro-optic crystal layer 32B formed in the second chip 3B. Therefore, the electric field flowing from the outward path side fifth waveguide 34A1 in the electric field direction a1 and the electric field flowing from the return path side fifth waveguide 34A2 in the electric field direction a2 are the same directions. In other words, the electric field flowing from the outward path side fifth waveguide 34A1 in the electric field direction a1 and the electric field flowing from the return path side fifth waveguide 34A2 in the electric field direction a2 are not canceled out, so that the modulation efficiency is accordingly enhanced.

The electric field direction b1 of the outward path side sixth waveguide 34B1 on which the first chip 3A is mounted is the direction opposite to the crystal direction (Z1 direction) of the electro-optic crystal layer 32A formed in the first chip 3A. The electric field direction b2 of the return path side sixth waveguide 34B2 on which the second chip 3B is mounted is the direction opposite to the crystal direction (Z2 direction) of the electro-optic crystal layer 32B formed in the second chip 3B. Therefore, the electric field flowing from the outward path side sixth waveguide 34B1 in the electric field direction b1 and the electric field flowing from the return path side sixth waveguide 34B2 in the electric field direction b2 are the same directions. In other words, the electric field flowing from the outward path side sixth waveguide 34B1 in the electric field direction b1 and the electric field flowing from the return path side sixth waveguide 34B2 in the electric field direction b2 are not canceled out, so that the modulation efficiency is accordingly enhanced.

The first chip 3A according to the first embodiment includes the first electrode that is arranged in the vicinity of the outward path side fifth waveguide 34A1, and that applies an electric field flowing in the same direction as the orientation of the crystal axis of the first chip 3A to the outward path side fifth waveguide 34A1. The second chip 3B includes the second electrode that is arranged in the vicinity of the return path side fifth waveguide 34A2, and that applies an electric field flowing in the same direction as the orientation of the crystal axis of the second chip 3B to the return path side fifth waveguide 34A2. As a result of this, the electric field flowing from the outward path side fifth waveguide 34A1 in the electric field direction a1 and the electric field flowing from the return path side fifth waveguide 34A2 in the electric field direction a2 are not canceled out, so that the modulation efficiency is accordingly enhanced.

The first chip 3A is mounted on the substrate 11 such that the orientation of Z1 of the crystal axis of the first chip 3A is orthogonal to the propagation direction of light passing through each of the outward path side fifth waveguide 34A1 and the outward path side sixth waveguide 34B1. The second chip 3B is mounted on the substrate 11 such that the orientation of Z2 of the crystal axis of the second chip 3B is orthogonal to the propagation direction of light passing through each of the return path side fifth waveguide 34A2 and the return path side sixth waveguide 34B2. As a result of this, the electric field flowing from the outward path side fifth waveguide 34A1 in the electric field direction a1 and the electric field flowing from the return path side fifth waveguide 34A2 in the electric field direction a2 are not canceled out, so that the modulation efficiency is accordingly enhanced. Furthermore, the electric field flowing from the outward path side sixth waveguide 34B1 in the electric field direction b1 and the electric field flowing from the return path side sixth waveguide 34B2 in the electric field direction b2 are not canceled out, so that the modulation efficiency is accordingly enhanced. In other words, the first chip 3A and the second chip 3B are arranged such that the axis in which the strongest electro-optical effect is exerted faces the direction that is substantially orthogonal to the traveling direction of a high-frequency signal, and, furthermore, the phase modulation is not canceled out between the first chip 3A and the second chip 3B. In addition, it is possible for an X-cut optical modulator formed of a thin film LN to be folded in an optical modulation element without intersecting the signal lines and the optical waveguides.

The first electrode is arranged in the vicinity of the outward path side sixth waveguide 34B1, and applies an electric field flowing an inverse direction with respect to the orientation of the crystal axis of the first chip 3A to the outward path side sixth waveguide 34B1. The second electrode is arranged in the vicinity of the return path side sixth waveguide 34B2, and applies an electric field flowing in the inverse direction with respect to the orientation of the crystal axis of the second chip 3B to the return path side sixth waveguide 34B2. As a result of this, the electric field flowing from the outward path side sixth waveguide 34B1 in the electric field direction b1 and the electric field flowing from the return path side sixth waveguide 34B2 in the electric field direction b2 are not canceled out, so that the modulation efficiency is accordingly enhanced.

The first chip 3A and the second chip 3B are mounted on the substrate 11 such that the orientation of Z1 of the crystal axis of the first chip 3A is 180 degrees different from the orientation of Z2 of the crystal axis of the second chip 3B. As a result of this, the electric field flowing from the outward path side fifth waveguide 34A1 in the electric field direction a1 and the electric field flowing from the return path side fifth waveguide 34A2 in the electric field direction a2 are not canceled out, so that the modulation efficiency is accordingly enhanced. Furthermore, the electric field flowing from the outward path side sixth waveguide 34B1 in the electric field direction b1 and the electric field flowing from the return path side sixth waveguide 34B2 in the electric field direction b2 are not canceled out, so that the modulation efficiency is accordingly enhanced.

The first chip 3A and the second chip 3B are mounted on the substrate 11 such that the orientation of a1 of the electric field that is applied from the first electrode to the outward path side fifth waveguide 34A1 is 180 degrees different from the orientation of a2 of the electric field that is applied from the second electrode to the return path side fifth waveguide 34A2. As a result of this, the electric field flowing from the outward path side fifth waveguide 34A1 in the electric field direction a1 and the electric field flowing from the return path side fifth waveguide 34A2 in the electric field direction a2 are not canceled out, so that the modulation efficiency is accordingly enhanced.

The first folded waveguide 51A is a folded waveguide in which the propagation direction of the light passing through the outward path side fifth waveguide 34A1 and the propagation direction of the light passing through the return path side fifth waveguide 34A2 change 180 degrees. The second folded waveguide 51B is a folded waveguide in which the propagation direction of the light passing through the outward path side sixth waveguide 34B1 and the propagation direction of the light passing through the return path side sixth waveguide 34B2 change 180 degrees. As a result of this, it is possible to improve a reduction in size of the optical modulator 1.

The outward path side first waveguide 14A1 allows the outward path side third waveguide 24A1 provided on the substrate 11 to be optically coupled to the outward path side fifth waveguide 34A1 on which the first chip 3A mounted. The return path side first waveguide 14A2 allows the return path side third waveguide 24A2 provided on the substrate 11 to be optically coupled to the return path side fifth waveguide 34A2 on which the second chip 3B is mounted. It is possible to mount the first chip 3A and the second chip 3B that are formed of the thin film LN on the substrate 11 made of Si.

The optical waveguide 14 that is provided on the substrate 11 on which the chip 2 is mounted and that is included in the optical modulator 1 according to the first embodiment has been exemplified to have a channel structure, but the embodiment is not limited to the channel structure, and appropriate modifications are possible. Accordingly, an embodiment of the optical waveguide 14 having a rib structure will be described below as a second embodiment.

### (b) Second Embodiment

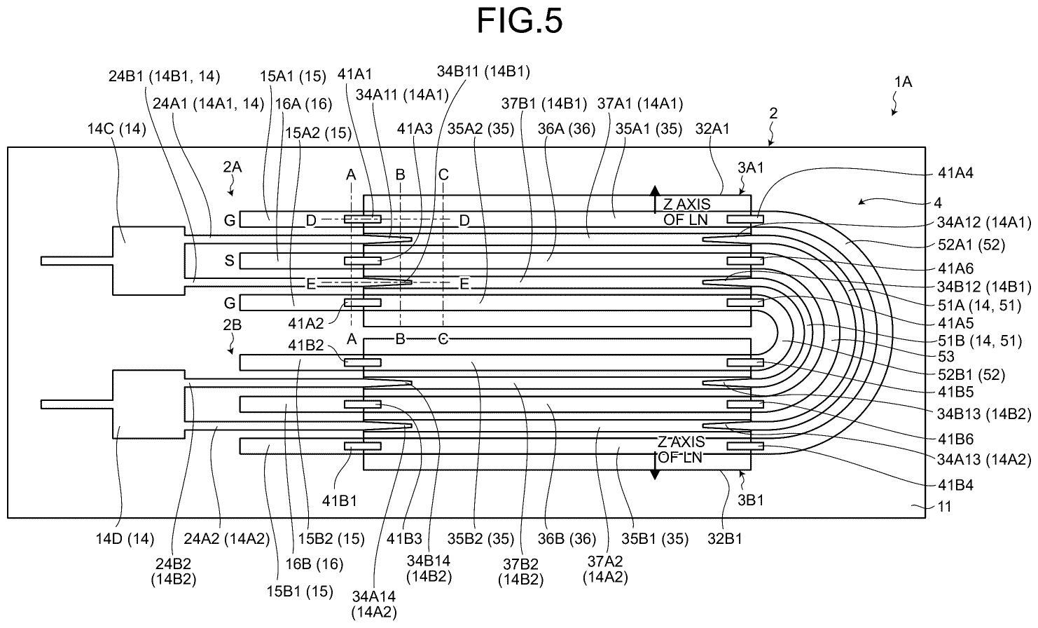

FIG. 5 is a schematic plan diagram illustrating one example of an optical modulator 1A according to the second embodiment. Moreover, by assigning the same reference numerals to components having the same configuration as those in the optical modulator 1 according to the first embodiment, overlapped descriptions of the configuration and the operation thereof will be omitted. The optical modulator 1A according to the second embodiment is different from the optical modulator 1 according to the first embodiment in that the optical waveguide 14 included in a first chip 3A1 and a second chip 3B1 is constituted to have a rib structure.

Each of the first chip 3A1 and the second chip 3B1 is a chip that is mounted on the substrate 11, that includes, for example, LN (LiNbO₃) as a material having an electro-optical effect that is higher than that of the substrate 11, and that has a crystal axis in which the strongest electro-optical effect is exerted. Moreover, as the material having the electro-optical effect, any material may be used as long as, for example, γ 33 is equal to or greater than 25 pm/V, and appropriate modifications are possible. Each of the first chip 3A1 and the second chip 3B1 is formed of, for example, an X-cut thin film LN. Each of the first chip 3A1 and the second chip 3B1 is accordingly mounted on the substrate 11 by using a thin film transfer technology, for example, a micro transfer printing (μ-TP) technology. In other words, each of the first chip 3A1 and the second chip 3B1 is mounted on the substrate 11 such that the Z-axis direction is not shared.

The first chip 3A1 included in the optical modulator 1A illustrated in FIG. 5 includes an outward path side seventh waveguide 37A1 and an outward path side eighth waveguide 37B1 each having a rib structure, and the second chip 3B1 includes a return path side seventh waveguide 37A2 and a return path side eighth waveguide 37B2 each having a rib structure.

The outward path side first waveguide 14A1 includes the outward path side third waveguide 24A1, an outward path side first tapered waveguide 34A11, the outward path side seventh waveguide 37A1, and an outward path side first inverse tapered waveguide 34A12. The outward path side third waveguide 24A1 is a waveguide that optically connects a portion between the first coupler 14C and the outward path side first tapered waveguide 34A11. The outward path side third waveguide 24A1 is a waveguide made of, for example, Si, or the like. Moreover, the outward path side third waveguide 24A1 is not limited to the Si waveguide, but may be formed of a material made of, for example, SiN, LN, or the like, and appropriate modifications are possible.

The outward path side first tapered waveguide 34A11 is a waveguide that is optically connected to the outward path side third waveguide 24A1 and has a tapered shape in which the waveguide width of the outward path side first tapered waveguide 34A11 is gradually narrower toward the outward path side seventh waveguide 37A1. The outward path side first tapered waveguide 34A11 is a waveguide made of, for example, Si, or the like. Moreover, the outward path side first tapered waveguide 34A11 is not limited to the Si waveguide, but may be formed of a material made of, for example, SiN, LN, or the like, and appropriate modifications are possible.

The outward path side first inverse tapered waveguide 34A12 is a waveguide that is optically connected to the first folded waveguide 51A, and that has a tapered shape in which the waveguide width of the outward path side first inverse tapered waveguide 34A12 is gradually wider toward the first folded waveguide 51A. The outward path side first inverse tapered waveguide 34A12 is a waveguide made of, for example, Si, or the like. Moreover, the outward path side first inverse tapered waveguide 34A12 is not limited to the Si waveguide, but may be formed of a material made of, for example, SiN, LN, or the like, and appropriate modifications are possible.

The outward path side seventh waveguide 37A1 is a waveguide in which the outward path side first tapered waveguide 34A11 is arranged at a lower portion of an input section of the outward path side seventh waveguide 37A1, and that has a rib structure in which a portion between the outward path side seventh waveguide 37A1 and the outward path side first tapered waveguide 34A11 are optically connected on the basis of an indirect transition. The outward path side seventh waveguide 37A1 is, for example, an LN waveguide. The outward path side seventh waveguide 37A1 is constituted to have a structure in which the outward path side first inverse tapered waveguide 34A12 is arranged at a lower portion of an output section of the outward path side seventh waveguide 37A1, and a portion between the outward path side seventh waveguide 37A1 and the outward path side first inverse tapered waveguide 34A12 are optically connected on the basis of an indirect transition.

The outward path side second waveguide 14B1 includes the outward path side fourth waveguide 24B1, an outward path side second tapered waveguide 34B11, the outward path side eighth waveguide 37B1, and an outward path side second inverse tapered waveguide 34B12. The outward path side fourth waveguide 24B1 is a waveguide that optically connects a portion between the first coupler 14C and the outward path side second tapered waveguide 34B11. The outward path side fourth waveguide 24B1 is a waveguide made of, for example, Si, or the like. Moreover, the outward path side fourth waveguide 24B1 is not limited to the Si waveguide, but may be formed of a material made of, for example, SiN, LN, or the like, and appropriate modifications are possible.

The outward path side second tapered waveguide 34B11 is a waveguide that is optically connected to the outward path side fourth waveguide 24B1, and that has a tapered shape in which the waveguide width of the outward path side second tapered waveguide 34B11 is gradually narrower toward the outward path side eighth waveguide 37B1. The outward path side second tapered waveguide 34B11 is a waveguide made of, for example, Si, or the like. Moreover, the outward path side second tapered waveguide 34B11 is not limited to the Si waveguide, but may be formed of a material made of, for example, SiN, LN, or the like, and appropriate modifications are possible.

The outward path side second inverse tapered waveguide 34B12 is a waveguide that is optically connected to the second folded waveguide 51B, and that has a tapered shape in which the waveguide width of the outward path side second inverse tapered waveguide 34B12 is gradually wider toward the second folded waveguide 51B. The outward path side second inverse tapered waveguide 34B12 is a waveguide made of, for example, Si, or the like. Moreover, the outward path side second inverse tapered waveguide 34B12 is not limited to the Si waveguide, but may be formed of a material made of, for example, SiN, LN, or the like, and appropriate modifications are possible.

The outward path side eighth waveguide 37B1 is a waveguide in which the outward path side second tapered waveguide 34B11 is arranged at a lower portion of an input section of the outward path side eighth waveguide 37B1, and that has a rib structure in which a portion between the outward path side eighth waveguide 37B1 and the outward path side second tapered waveguide 34B11 are optically connected on the basis of an indirect transition. The outward path side eighth waveguide 37B1 is, for example, an LN waveguide. The outward path side eighth waveguide 37B1 is constituted to have a structure in which the outward path side second inverse tapered waveguide 34B12 is arranged at a lower portion of an output section of the outward path side eighth waveguide 37B1, and a portion between the outward path side eighth waveguide 37B1 and the outward path side second inverse tapered waveguide 34B12 are optically connected on the basis of an indirect transition.

The return path side first waveguide 14A2 includes a return path side first inverse tapered waveguide 34A13, the return path side seventh waveguide 37A2, a return path side first tapered waveguide 34A14, and the return path side third waveguide 24A2. The return path side first inverse tapered waveguide 34A13 is a waveguide that is optically connected to the first folded waveguide 51A, and that has a tapered shape in which the waveguide width of the return path side first inverse tapered waveguide 34A13 is gradually narrower toward the return path side seventh waveguide 37A2. The return path side first inverse tapered waveguide 34A13 is a waveguide made of, for example, Si, or the like. Moreover, the return path side first inverse tapered waveguide 34A13 is not limited to the Si waveguide, but may be formed of a material made of, for example, SiN, LN, or the like, and appropriate modifications are possible.

The return path side first tapered waveguide 34A14 is a waveguide that is optically connected to the return path side third waveguide 24A2, and that has a tapered shape in which the waveguide width of the return path side first tapered waveguide 34A14 is gradually wider toward the return path side seventh waveguide 37A2. The return path side first tapered waveguide 34A14 is a waveguide made of, for example, Si, or the like. Moreover, the return path side first tapered waveguide 34A14 is not limited to the Si waveguide, but may be formed of a material made of, for example, SiN, LN, or the like, and appropriate modifications are possible.

The return path side third waveguide 24A2 is a waveguide that optically connects a portion between the second coupler 14D and the return path side first tapered waveguide 34A14. The return path side third waveguide 24A2 is a waveguide made of, for example, Si, or the like. Moreover, the return path side third waveguide 24A2 is not limited to the Si waveguide, but may be formed of a material made of, for example, SiN, LN, or the like, and appropriate modifications are possible.

The return path side seventh waveguide 37A2 is a waveguide in which the return path side first inverse tapered waveguide 34A13 is arranged at a lower portion of an input section of the return path side seventh waveguide 37A2, and that has a rib structure in which a portion between the return path side seventh waveguide 37A2 and the return path side first inverse tapered waveguide 34A13 are optically connected on the basis of an indirect transition. The return path side seventh waveguide 37A2 is, for example, an LN waveguide. The return path side seventh waveguide 37A2 is constituted to have a structure in which the return path side first tapered waveguide 34A14 is arranged at a lower portion of an output section of the return path side seventh waveguide 37A2, and a portion between the return path side seventh waveguide 37A2 and the return path side first tapered waveguide 34A14 are optically connected on the basis of an indirect transition.

The return path side second waveguide 14B2 includes a return path side second inverse tapered waveguide 34B13, the return path side eighth waveguide 37B2, a return path side second tapered waveguide 34B14, and the return path side fourth waveguide 24B2. The return path side second inverse tapered waveguide 34B13 is a waveguide that is optically connected to the second folded waveguide 51B, and that has a tapered shape in which the waveguide width of the return path side second inverse tapered waveguide 34B13 is gradually narrower toward the return path side eighth waveguide 37B2. the return path side second inverse tapered waveguide 34B13 is a waveguide made of, for example, Si, or the like. Moreover, the return path side second inverse tapered waveguide 34B13 is not limited to the Si waveguide, but may be formed of a material made of, for example, SiN, LN, or the like, and appropriate modifications are possible.

The return path side second tapered waveguide 34B14 is a waveguide that is optically connected to the return path side fourth waveguide 24B2, and that has a tapered shape in which the waveguide width of the return path side second tapered waveguide 34B14 is gradually wider toward the return path side eighth waveguide 37B2. The return path side second tapered waveguide 34B14 is a waveguide made of, for example, Si, or the like. Moreover, the return path side second tapered waveguide 34B14 is not limited to the Si waveguide, but may be formed of a material made of, for example, SiN, LN, or the like, and appropriate modifications are possible.

The return path side fourth waveguide 24B2 is a waveguide that optically connects a portion between the second coupler 14D and the return path side second tapered waveguide 34B14. The return path side fourth waveguide 24B2 is a waveguide made of, for example, Si, or the like. Moreover, the return path side fourth waveguide 24B2 is not limited to the Si waveguide, but may be formed of a material made of, for example, SiN, LN, or the like, and appropriate modifications are possible.

The return path side eighth waveguide 37B2 is a waveguide in which the return path side second inverse tapered waveguide 34B13 is arranged at a lower portion of an input section of the return path side eighth waveguide 37B2, and that has a rib structure in which a portion between the return path side eighth waveguide 37B2 and the return path side second inverse tapered waveguide 34B13 are optically connected on the basis of an indirect transition. The return path side eighth waveguide 37B2 is, for example, an LN waveguide. The return path side eighth waveguide 37B2 is constituted to have a structure in which the return path side second tapered waveguide 34B14 is arranged at a lower portion of an output section of the return path side eighth waveguide 37B2, and a portion between the return path side eighth waveguide 37B2 and the return path side second tapered waveguide 34B14 are optically connected on the basis of an indirect transition.

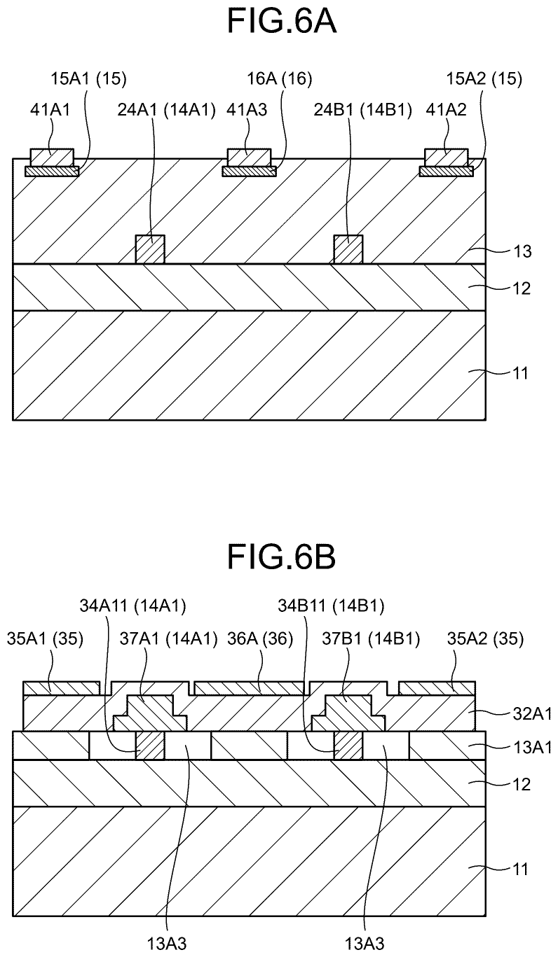

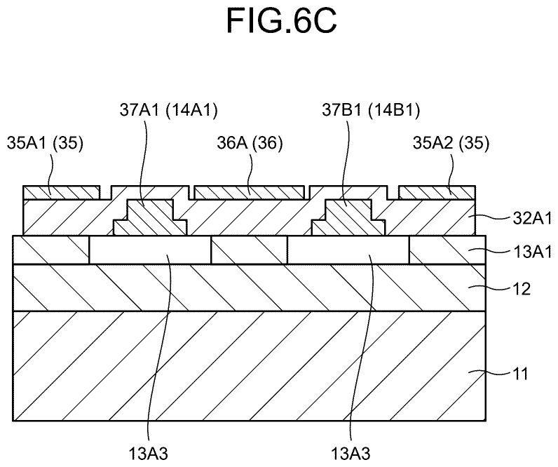

FIG. 6A is a schematic cross-sectional diagram illustrating one example of a cross-sectional part taken along line A-A illustrated in FIG. 5. The cross-sectional part taken along line A-A is a cross-sectional part of the outward path side third waveguide 24A1 and the outward path side fourth waveguide 24B1 that are included in the chip 2. The optical modulator 1A illustrated in FIG. 6A includes the substrate 11, the lower part clad 12 that is laminated on the substrate 11, and the outward path side third waveguide 24A1 and the outward path side fourth waveguide 24B1 that are laminated on the lower part clad 12. Furthermore, the optical modulator 1A includes the upper part clad 13 that is formed to cover the outward path side third waveguide 24A1 and the outward path side fourth waveguide 24B1. The optical modulator 1A includes the first electrode that is formed in the upper part clad 13, and that includes the first signal electrode 16A, the first ground electrode 15A1, and the first ground electrode 15A2.

The first electrode includes the connecting portion 41A3 that electrically connects a portion between the first signal electrode 16A included in the chip 2 and the first signal electrode 36A included in the first chip 3A1. The first electrode includes the connecting portion 41A1 that electrically connects a portion between the first ground electrode 15A1 included in the chip 2 and the first ground electrode 35A1 included in the first chip 3A1. The first electrode includes the connecting portion 41A2 that electrically connects a portion between the first ground electrode 15A2 included in the chip 2 and the first ground electrode 35A2 included in the first chip 3A1.

Moreover, in FIG. 6A, the description has been given by focusing on the first electrode included in the chip 2, and the same applies to the second electrode included in the chip 2. The optical modulator 1A includes the return path side third waveguide 24A2 and the return path side fourth waveguide 24B2, and also includes the upper part clad 13 that is formed to cover both of the return path side third waveguide 24A2 and the return path side fourth waveguide 24B2. The optical modulator 1A includes the second electrode that is formed in the upper part clad 13, and that includes the second signal electrode 16B, the second ground electrode 15B1, and the second ground electrode 15B2.

The second electrode includes the connecting portion 41B3 that electrically connects a portion between the second signal electrode 16B included in the chip 2 and the second signal electrode 36B included in the second chip 3B1. The second electrode includes the connecting portion 41B1 that electrically connects a portion between the second ground electrode 15B1 included in the chip 2 and the second ground electrode 35B1 included in the second chip 3B1. The second electrode includes the connecting portion 41B2 that electrically connects a portion between the second ground electrode 15B2 included in the chip 2 and the second ground electrode 35B2 included in the second chip 3B1.

FIG. 6B is a schematic cross-sectional diagram illustrating one example of a cross-sectional part taken along line B-B illustrated in FIG. 5. The cross-sectional part taken along line B-B is a cross-sectional part of the outward path side seventh waveguide 37A1 and the outward path side eighth waveguide 37B1 that are included in the first chip 3A1. The optical modulator 1A illustrated in FIG. 6B includes the substrate 11, the lower part clad 12 that is laminated on the substrate 11, an upper part clad 13A1 that is laminated on the lower part clad 12, and the first chip 3A1 that is mounted on the upper part clad 13A1. Moreover, the upper part clad 13A1 is a clad layer that is formed such that the upper part clad 13 illustrated in FIG. 6A is etched, or the like.

The first chip 3A1 includes the outward path side first tapered waveguide 34A11 and the outward path side second tapered waveguide 34B11 that are arranged at the opening portion 13A3 formed in the upper part clad 13A1, and that are also arranged on the lower part clad 12. The first chip 3A1 includes an electro-optic crystal layer 32A1 that is mounted on the upper part clad 13A1, and also includes the outward path side seventh waveguide 37A1 and the outward path side eighth waveguide 37B1 that are constituted by the electro-optic crystal layer 32A1. The first chip 3A1 includes the first electrode that that includes the first signal electrode 16A, the first ground electrode 15A1, and the first ground electrode 15A2, and is formed on the electro-optic crystal layer 32A1.

The outward path side seventh waveguide 37A1 is constituted by a rib type waveguide, and optically connects a portion between the outward path side seventh waveguide 37A1 and the outward path side first tapered waveguide 34A11 on the basis of an indirect transition. The outward path side eighth waveguide 37B1 is constituted by a rib type waveguide, and optically connects a portion between the outward path side eighth waveguide 37B1 and the outward path side second tapered waveguide 34B11 on the basis of an indirect transition.

The first electrode includes the first signal electrode 36A that is arranged in parallel with a portion between the outward path side first tapered waveguide 34A11 and the outward path side second tapered waveguide 34B11, and that is also arranged in parallel with a portion between the outward path side seventh waveguide 37A1 and the outward path side eighth waveguide 37B1. The first electrode includes the first ground electrode 35A1 that is arranged in parallel with the outward path side first tapered waveguide 34A11, and that is also arranged in parallel with the outward path side seventh waveguide 37A1. The first electrode includes the first ground electrode 35A2 that is arranged in parallel with the outward path side second tapered waveguide 34B11, and that is also arranged in parallel with the outward path side eighth waveguide 37B1.

Moreover, in FIG. 6B, the description has been given by focusing on the first chip 3A1, and the same applies to the second chip 3B1. The optical modulator 1A includes the second chip 3B1 that is mounted on the upper part clad 13A1. The second chip 3B1 includes the return path side first tapered waveguide 34A14 and the return path side second tapered waveguide 34B14 that are arranged at the opening portion 13A3 of the upper part clad 13A1, and that are also arranged on the lower part clad 12. The second chip 3B1 includes an electro-optic crystal layer 32B1 that is mounted on the upper part clad 13A1, and also includes the return path side seventh waveguide 37A2 and the return path side eighth waveguide 37B2 that are constituted by the electro-optic crystal layer 32B1. The second chip 3B1 includes the second electrode that includes the second signal electrode 16B, the second ground electrode 15B1, and the second ground electrode 15B2, and that is formed on the electro-optic crystal layer 32B1.

The return path side seventh waveguide 37A2 is constituted by a rib type waveguide, and optically connects a portion between the return path side seventh waveguide 37A2 and the return path side first tapered waveguide 34A14 on the basis of an indirect transition. The return path side eighth waveguide 37B2 is constituted by a rib type waveguide, and optically connects a portion between the return path side eighth waveguide 37B2 and the return path side second tapered waveguide 34B14 on the basis of an indirect transition.

The second electrode is arranged in parallel with a portion between the return path side first tapered waveguide 34A14 and the return path side second tapered waveguide 34B14, and includes the second signal electrode 36B that is arranged in parallel with a portion between the return path side seventh waveguide 37A2 and the return path side eighth waveguide 37B2. The second electrode includes the second ground electrode 35B1 that is arranged in parallel with the return path side first tapered waveguide 34A14, and that is also arranged in parallel with the return path side seventh waveguide 37A2. The second electrode includes the second ground electrode 35B2 that is arranged in parallel with the return path side second tapered waveguide 34B14, and that is also arranged in parallel with the return path side eighth waveguide 37B2.

FIG. 6C is a schematic cross-sectional diagram illustrating one example of a cross-sectional part taken along line C-C illustrated in FIG. 5. The cross-sectional part taken along line C-C is a cross-sectional part of the outward path side seventh waveguide 37A1 and the outward path side eighth waveguide 37B1 that are included in the first chip 3A1. The optical modulator 1A illustrated in FIG. 6C includes the substrate 11, the lower part clad 12 that is laminated on the substrate 11, the upper part clad 13A1 that is laminated on the lower part clad 12, and the first chip 3A1 that is mounted on the upper part clad 13A1.

The first chip 3A1 includes the electro-optic crystal layer 32A1 that is mounted on the upper part clad 13A1, and also includes the outward path side seventh waveguide 37A1 and the outward path side eighth waveguide 37B1 that are constituted by the electro-optic crystal layer 32A1. The first chip 3A1 includes the first electrode that includes the first signal electrode 36A, the first ground electrode 35A1, and the first ground electrode 35A2, and that is formed on the electro-optic crystal layer 32A1.

Moreover, in FIG. 6C, the description has been given by focusing on the first chip 3A1, and the same applies to the second chip 3B1. The optical modulator 1A includes the second chip 3B1 that is mounted on the upper part clad 13A1. The second chip 3B1 includes the electro-optic crystal layer 32B1 that is mounted on the upper part clad 13A1, and also includes the return path side seventh waveguide 37A2 and the return path side eighth waveguide 37B2 that are constituted by the electro-optic crystal layer 32B1. The second chip 3B1 includes the second electrode that includes the second signal electrode 36B, the second ground electrode 35B1, and the second ground electrode 35B2, and that is formed on the electro-optic crystal layer 32B1.

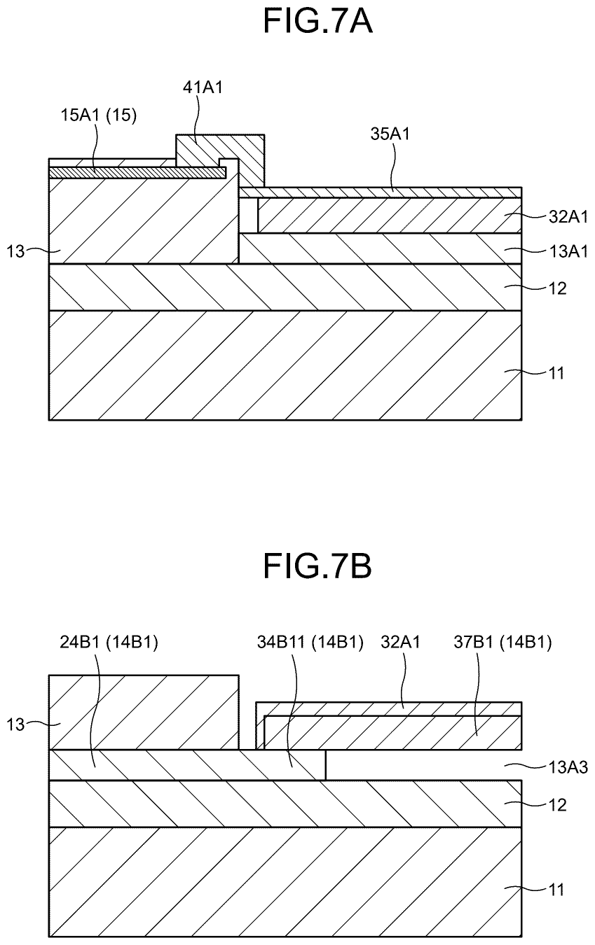

FIG. 7A is a schematic cross-sectional diagram of one example of a cross-sectional part taken along line D-D illustrated in FIG. 5. The cross-sectional part taken along line D-D is a cross-sectional part of the optical modulator 1A that electrically connects a portion between the first ground electrode 15A1 included in the chip 2 and the first ground electrode 35A1 included in the first chip 3A1. The optical modulator 1A illustrated in FIG. 7A includes the upper part clad 13 and the upper part clad 13A1 that are laminated on the lower part clad 12, and also includes the first ground electrode 15A1 that is arranged in the upper part clad 13. The optical modulator 1A includes the electro-optic crystal layer 32A1 formed in the first chip 3A1 that is mounted on the upper part clad 13A1, and also includes the first ground electrode 35A1 that is arranged on the electro-optic crystal layer 32A1. The optical modulator 1A electrically connects a portion between the first ground electrode 15A1 that is arranged in the upper part clad 13 included in the chip 2 and the first ground electrode 35A1 that is arranged on the electro-optic crystal layer 32A1 included in the first chip 3A1 by using the connecting portion 41A1.

Moreover, in FIG. 7A, the description has been given by focusing on the first chip 3A1, and the same applies to the second chip 3B1. The optical modulator 1A includes the upper part clad 13 and the upper part clad 13A1 that are laminated on the lower part clad 12, and the second ground electrode 15B1 that is arranged in the upper part clad 13. The optical modulator 1A includes the electro-optic crystal layer 32B1 provided in the second chip 3B1 that is mounted on the upper part clad 13A1, and the second ground electrode 35B1 that is arranged on the electro-optic crystal layer 32B1. The optical modulator 1A electrically connects a portion between the second ground electrode 15B1 that is arranged in the upper part clad 13 included in the chip 2 and the second ground electrode 35B1 that is arranged on the electro-optic crystal layer 32B1 included in the second chip 3B1 by using the connecting portion 41B1.

FIG. 7B is a schematic cross-sectional diagram illustrating one example of a cross-sectional part taken along line E-E illustrated in FIG. 5. The cross-sectional part taken along line E-E is a cross-sectional part of the optical modulator 1A that optically connects a portion between the outward path side fourth waveguide 24B1 and the outward path side second tapered waveguide 34B11 that are included in the chip 2 and the outward path side eighth waveguide 37B1 that is included in the first chip 3A1. The optical modulator 1A illustrated in FIG. 7B includes the outward path side fourth waveguide 24B1 and the outward path side second tapered waveguide 34B11 that are arranged on the lower part clad 12, and also includes the upper part clad 13 that covers the outward path side fourth waveguide 24B1. The optical modulator 1A includes the electro-optic crystal layer 32A1 that is arranged on the outward path side eighth waveguide 37B1.

Moreover, in FIG. 7B, the description has been given by focusing on the first chip 3A1, and the same applies to the second chip 3B1. The optical modulator 1A includes the return path side fourth waveguide 24B2 and the return path side second tapered waveguide 34B14 that are arranged on the lower part clad 12, and also includes the upper part clad 13 that covers the return path side fourth waveguide 24B2. The optical modulator 1A includes the electro-optic crystal layer 32B1 that is arranged on the return path side eighth waveguide 37B2.

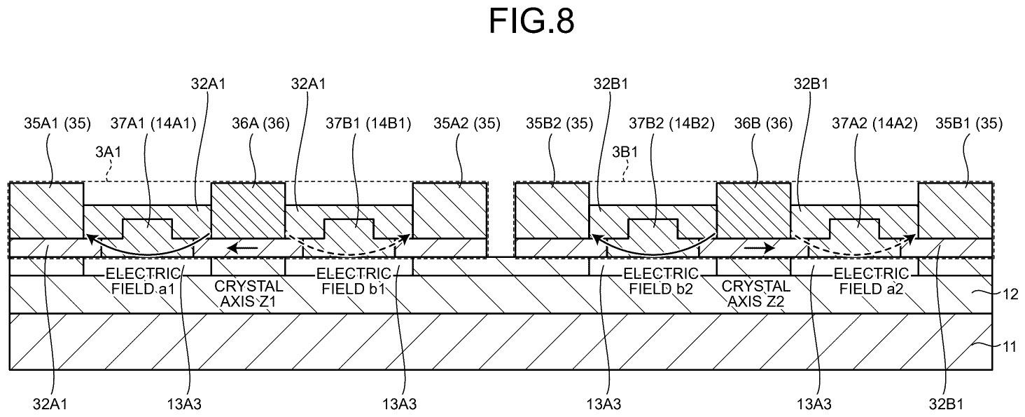

FIG. 8 is a schematic cross-sectional diagram illustrating one example of a cross-sectional part taken along line F-F illustrated in FIG. 5. The orientation of Z1 of the crystal axis of the electro-optic crystal layer 32A1 included in the first chip 3A1 is a width direction (Z direction) that is orthogonal to the traveling direction (Y direction) of light. In the outward path side seventh waveguide 37A1 included in the first chip 3A1, an optical refractive index is changed in accordance with an electric field flowing in an electric field direction a1 from the first signal electrode 36A to the first ground electrode 35A1. Furthermore, in the outward path side eighth waveguide 37B1 included in the first chip 3A1, an optical refractive index is changed in accordance with an electric field flowing in an electric field direction b1 from the first signal electrode 36A to the first ground electrode 35A2.

The orientation of Z2 of the crystal axis of the electro-optic crystal layer 32B1 formed in the second chip 3B1 is a width direction (Z direction) that is orthogonal to the traveling direction (Y direction) of light. The orientation of Z1 of the crystal axis of the electro-optic crystal layer 32A1 formed in the first chip 3A1 is 180 degrees different from the orientation of Z2 of the crystal axis of the electro-optic crystal layer 32B1 formed in the second chip 3B1. In the return path side seventh waveguide 37A2 included in the second chip 3B1, an optical refractive index is changed in accordance with an electric field flowing in the electric field direction a2 from the second signal electrode 36B to the second ground electrode 35B1. Furthermore, in the return path side eighth waveguide 37B2 included in the second chip 3B1, an optical refractive index is changed in accordance with an electric field flowing in from the second signal electrode 36B to the second ground electrode 35B2.

The electric field direction a1 of the outward path side seventh waveguide 37A1 included in the first chip 3A1 is the same as the crystal direction (Z1 direction) of the electro-optic crystal layer 32A1. The electric field direction a2 of the return path side seventh waveguide 37A2 included in the second chip 3B1 is the same as the crystal direction (Z2 direction) of the electro-optic crystal layer 32B1. Therefore, the electric field flowing from the outward path side seventh waveguide 37A1 in the electric field direction a1 and the electric field flowing from the return path side seventh waveguide 37A2 in the electric field direction a2 are the same directions. In other words, the electric field flowing from the outward path side seventh waveguide 37A1 in the electric field direction a1 and the electric field flowing from the return path side seventh waveguide 37A2 in the electric field direction a2 are not canceled out, so that the modulation efficiency is accordingly enhanced.

The electric field direction b1 of the outward path side eighth waveguide 37B1 included in the first chip 3A1 is the direction opposite to the crystal direction (Z1 direction) of the electro-optic crystal layer 32A1. The electric field direction b2 of the return path side eighth waveguide 37B2 included in the second chip 3B1 is the direction opposite to the crystal direction (Z2 direction) of the electro-optic crystal layer 32B1. Therefore, the direction of the electric field flowing from the outward path side eighth waveguide 37B1 in the electric field direction b1 and the direction of the electric field flowing from the return path side eighth waveguide 37B2 in the electric field direction b2 are the same directions. In other words, the electric field flowing from the outward path side eighth waveguide 37B1 in the electric field direction b1 and the electric field flowing from the return path side eighth waveguide 37B2 in the electric field direction b2 are not canceled out, so that the modulation efficiency is accordingly enhanced.

The first chip 3A1 according to the second embodiment includes the first electrode that is arranged in the vicinity of the outward path side seventh waveguide 37A1, and that applies an electric field flowing in the same direction as the orientation of the crystal axis of the first chip 3A1 to the outward path side seventh waveguide 37A1. The second chip 3B1 includes the second electrode that is arranged in the vicinity of the return path side seventh waveguide 37A2, and that applies an electric field flowing in the same direction as the orientation of the crystal axis of the second chip 3B1 to the return path side seventh waveguide 37A2. As a result of this, the electric field flowing from the outward path side seventh waveguide 37A1 in the electric field direction a1 and the electric field flowing from the return path side seventh waveguide 37A2 in the electric field direction a2 are not canceled out, so that the modulation efficiency is accordingly enhanced.

The first chip 3A1 is mounted on the substrate 11 such that the orientation of Z1 of the crystal axis of the first chip 3A1 is orthogonal to the propagation direction of light passing through each of the outward path side seventh waveguide 37A1 and the outward path side eighth waveguide 37B1. The second chip 3B1 is mounted on the substrate 11 such that the orientation of Z2 of the crystal axis of the second chip 3B1 is orthogonal to the propagation direction passing through each of the return path side seventh waveguide 37A2 and the return path side eighth waveguide 37B2. As a result of this, the electric field flowing from the outward path side seventh waveguide 37A1 in the electric field direction a1 and the electric field flowing from the return path side seventh waveguide 37A2 in the electric field direction a2 are not canceled out, so that the modulation efficiency is accordingly enhanced. Furthermore, the electric field flowing from the outward path side eighth waveguide 37B1 in the electric field direction b1 and the electric field flowing from the return path side eighth waveguide 37B2 in the electric field direction b2 are not canceled out, so that the modulation efficiency is accordingly enhanced. In other words, the first chip 3A1 and the second chip 3B1 are arranged such that the axis in which the strongest electro-optical effect is exerted faces the direction that is substantially orthogonal to the traveling direction of a high-frequency signal, and, furthermore, the phase modulation is not canceled out between the first chip 3A1 and the second chip 3B1. In addition, it is possible for an X-cut optical modulator formed of a thin film LN to be folded in an optical modulation element without intersecting the signal lines and the optical waveguides.

The first electrode is arranged in the vicinity of the outward path side eighth waveguide 37B1, and applies an electric field flowing an inverse direction with respect to the orientation of the crystal axis of the first chip 3A1 to the outward path side eighth waveguide 37B1. The second electrode is arranged in the vicinity of the return path side eighth waveguide 37B2, and applies an electric field flowing in the inverse direction with respect to the orientation of the crystal axis of the second chip 3B1 to the return path side eighth waveguide 37B2. As a result of this, the electric field flowing from the outward path side eighth waveguide 37B1 in the electric field direction b1 and the electric field flowing from the return path side eighth waveguide 37B2 in the electric field direction b2 are not canceled out, so that the modulation efficiency is accordingly enhanced.

The first chip 3A1 and the second chip 3B1 are mounted on the substrate 11 such that the orientation of Z1 of the crystal axis of the first chip 3A1 is 180 degrees different from the orientation of Z2 of the crystal axis of the second chip 3B1. As a result of this, the electric field flowing from the outward path side seventh waveguide 37A1 in the electric field direction a1 and the electric field flowing from the return path side seventh waveguide 37A2 in the electric field direction a2 are not canceled out, so that the modulation efficiency is accordingly enhanced. Furthermore, the electric field flowing from the outward path side eighth waveguide 37B1 in the electric field direction b1 and the electric field flowing from the return path side eighth waveguide 37B2 in the electric field direction b2 are not canceled out, so that the modulation efficiency is accordingly enhanced.

The first chip 3A1 and the second chip 3B1 are mounted on the substrate 11 such that the orientation of a1 of the electric field that is applied from the first electrode to the outward path side seventh waveguide 37A1 is 180 degrees different from the orientation of a2 the electric field that is applied from the second electrode to the return path side seventh waveguide 37A2. As a result of this, the electric field flowing from the outward path side seventh waveguide 37A1 in the electric field direction a1 and the electric field flowing from the return path side seventh waveguide 37A2 in the electric field direction a2 are not canceled out, so that the modulation efficiency is accordingly enhanced.

Each of the seventh waveguides 37A1 and 37A2 and the eighth waveguides 37B1 and 37B2 is a waveguide that is formed of the electro-optic crystal layer and that is constituted to have a rib structure. As a result of this, as compared with the optical modulator 1 according to the first embodiment, light is confined in only the electro-optic crystal, so that the modulation efficiency is accordingly enhanced. Moreover, in the optical modulator 1 according to the first embodiment, a waveguide mode also propagates through the waveguide that is provided on the substrate 11 side.

In the optical modulator 1 (1A) according to the present embodiment, the description has been given by focusing on a single piece of the MZM structure, but the optical modulator 1 (1A) may be applicable to an IQ modulator by providing two pieces of the MZM structure, and the optical modulator 1 (1A) may also applicable to a DP-IQ modulator by providing four pieces of the MZM structure.

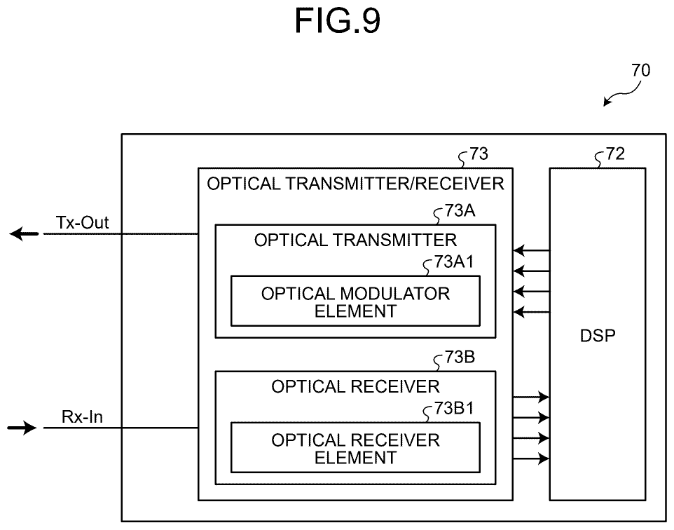

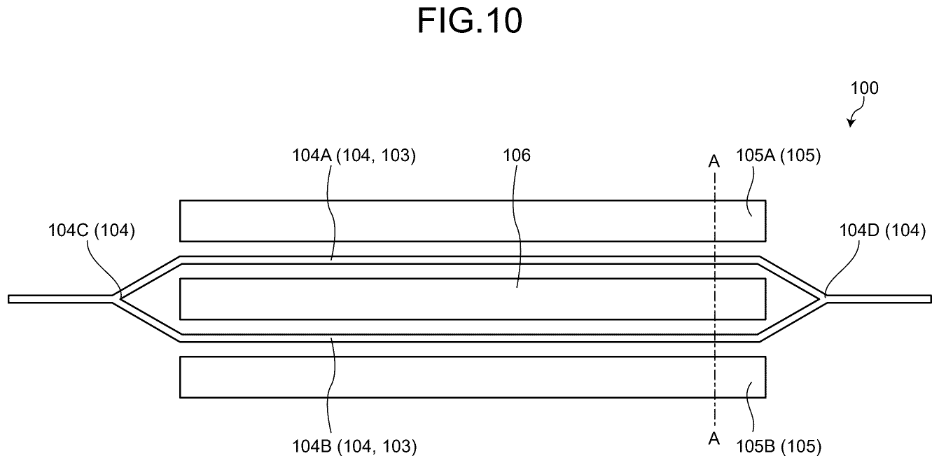

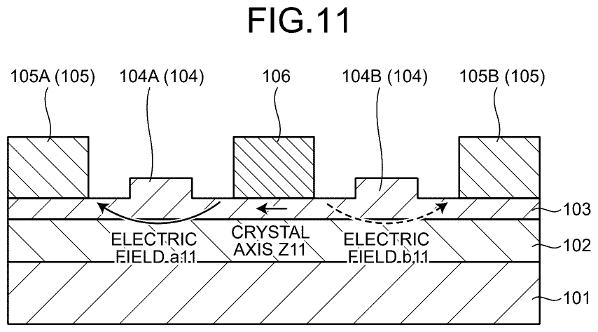

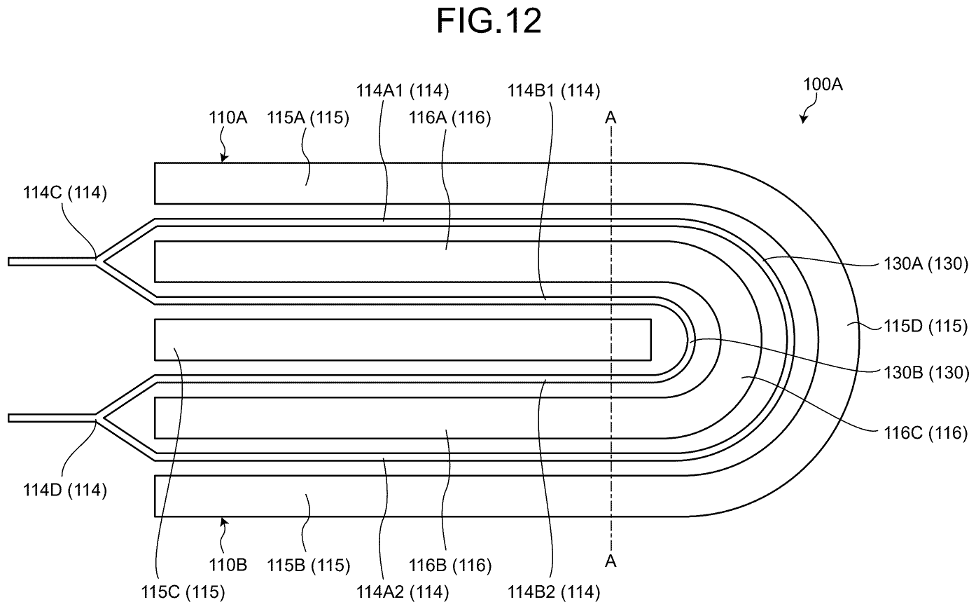

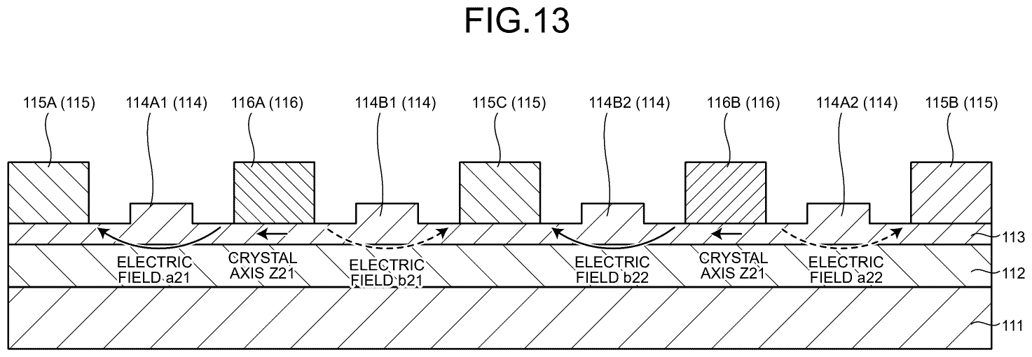

FIG. 9 is an explanation diagram illustrating one example of an optical transceiver 70 according to the present embodiment. The optical transceiver 70 illustrated in FIG. 9 is connected to an optical fiber disposed on an output side and an optical fiber disposed on an input side. The optical transceiver 70 includes a digital signal processor (DSP) 72, and an optical transmitter/receiver 73. The optical transmitter/receiver 73 includes an optical transmitter 73A, and an optical receiver 73B. The DSP 72 is an electrical component that performs digital signal processing. The DSP 72 performs a process of, for example, encoding transmission data or the like, generates an electrical signal that includes the transmission data, and outputs the generated electrical signal to the optical transmitter 73A. Furthermore, the DSP 72 acquires an electrical signal that includes reception data from the optical receiver 73B, performs a process of, for example, decoding the acquired electrical signal, and obtains the reception.

The optical transmitter 73A includes an optical modulator element 73A1 that modulates supplied light by using the electrical signal that is output from the DSP 72, and outputs the transmission light that has been modulated by the electrical signal to the optical fiber. The optical modulator element 73A1 includes an optical device as a built-in unit that guides light to be output to the optical fiber.

The optical receiver 73B includes an optical receiver element 73B1 that receives the optical signal from the optical fiber and that demodulates the reception light by using the supplied light, converts the demodulated reception light to an electrical signal, and outputs the converted electrical signal to the DSP 72.

The optical device included in the optical transceiver 70 includes a substrate, an optical waveguide that is provided on the substrate, a first chip and a second chip each of which is mounted on the substrate, includes a material having an electro-optical effect that is higher than that of the substrate, and includes a crystal axis in which the strongest electro-optical effect is exerted. The optical waveguide includes a first coupler, an input side first waveguide and an input side second waveguide that are connected to the first coupler. The optical waveguide includes a second coupler, an output side first waveguide and an output side second waveguide that are connected to the second coupler. The optical waveguide includes a first bent waveguide that connects a portion between the input side first waveguide and the output side first waveguide, and a second bent waveguide that connects a portion between the input side second waveguide and the output side second waveguide. The first chip is mounted on the substrate such that the orientation of the crystal axis of the first chip is orthogonal to the propagation direction of light passing through each of the input side first waveguide and the input side second waveguide.

The first chip includes a first electrode that is arranged in the vicinity of the input side first waveguide, and that applies an electric field flowing in the same direction as the orientation of the crystal axis of the first chip to the input side first waveguide. The second chip is mounted on the substrate such that the orientation of the crystal axis of the second chip is orthogonal to the propagation direction of light passing through each of the first waveguide provided on the output side and the second waveguide provided on the output side. The second chip includes a second electrode that is arranged in the vicinity of the first waveguide provided on the output side, and that applies an electric field flowing in the same direction as the orientation of the crystal axis of the second chip to the first waveguide provided on the output side. As a result of this, the optical device is able to improve enhancement of the modulation efficiency.

Moreover, for convenience of description, the case has been described as an example in which the optical transceiver 70 includes the optical transmitter 73A and the optical receiver 73B as built-in units, but the optical transceiver 70 may include one of the optical transmitter 73A and the optical receiver 73B. For example, an optical device may be applicable to the optical transceiver 70 that includes the optical receiver 73B as a built-in unit, and appropriate modifications are possible.

Furthermore, each of the components in the units illustrated in the drawings is not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

Furthermore, all or any part of various processing functions performed by each unit may also be executed by a central processing unit (CPU) (or, a microcomputer, such as a micro processing unit (MPU) or a micro controller unit (MCU)). In addition, all or any part of various processing functions may also be, of course, executed by programs analyzed and executed by the CPU (or the microcomputer, such as the MPU or the MCU), or executed by hardware by wired logic.

According to one aspect of an embodiment of the optical device disclosed in the present application, it is possible to improve enhancement of modulation efficiency.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a substrate;
an optical waveguide that is provided on the substrate; and
a first chip and a second chip each of which is mounted on the substrate, includes a material having an electro-optical effect that is higher than that of the substrate, and includes a crystal axis in which the strongest electro-optical effect is exerted, wherein
the optical waveguide includes
a first coupler,
an input side first waveguide and an input side second waveguide that are connected to the first coupler,
a second coupler,
an output side first waveguide and an output side second waveguide that are connected to the second coupler,
a first bent waveguide that connects a portion between the input side first waveguide and the output side first waveguide, and
a second bent waveguide that connects a portion between the input side second waveguide and the output side second waveguide,
the first chip includes
a first electrode that is arranged in the vicinity of the input side first waveguide, and that applies an electric field flowing in the same direction as an orientation of the crystal axis of the first chip to the input side first waveguide, and
the second chip includes
a second electrode that is arranged in the vicinity of the output side first waveguide, and that applies an electric field flowing in the same direction as an orientation of the crystal axis of the second chip to the output side first waveguide.

2. The optical device according to claim 1, wherein
the first chip is mounted on the substrate such that the orientation of the crystal axis of the first chip is orthogonal to a propagation direction of light passing through each of the input side first waveguide and the input side second waveguide, and
the second chip is mounted on the substrate such that the orientation of the crystal axis of the second chip is orthogonal to a propagation direction of light passing through each of the output side first waveguide and the output side second waveguide.

3. The optical device according to claim 1, wherein
the first electrode is arranged in the vicinity of the input side second waveguide, and applies an electric field flowing in an inverse direction with respect to the orientation of the crystal axis of the first chip to the input side second waveguide, and
the second electrode is arranged in the vicinity of the output side second waveguide, and applies an electric field flowing in an inverse direction with respect to the orientation of the crystal axis of the second chip to the output side second waveguide.

4. The optical device according to claim 1, wherein the first chip and the second chip are mounted on the substrate such that the orientation of the crystal axis of the first chip is 180 degrees different from the orientation of the crystal axis of the second chip.

5. The optical device according to claim 1, wherein the first chip and the second chip are mounted on the substrate such that the orientation of the electric field applied from the first electrode to the input side first waveguide is 180 degrees different from the orientation of the electric field applied from the second electrode to the output side first waveguide.

6. The optical device according to claim 1, wherein each of the first bent waveguide and the second bent waveguide is a folded waveguide in which the propagation direction of the light passing through each of the input side first waveguide and the input side second waveguide is 180 degrees different from the propagation direction of the light passing through each of the output side first waveguide and the output side second waveguide.

7. The optical device according to claim 1, wherein
the input side first waveguide is configured by allowing an input side third waveguide provided on the substrate to be optically coupled to an input side fourth waveguide provided on the first chip, and
the output side first waveguide is configured by allowing an output side fifth waveguide provided on the substrate to be optically coupled to an output side sixth waveguide provided on the second chip.

8. The optical device according to claim 7, wherein each of the fourth waveguide and the sixth waveguide is a waveguide having a rib structure.

9. The optical device according to claim 1, wherein
the first electrode is an electrode having a coplanar structure that includes
a first signal electrode that is arranged in parallel with a portion between the input side first waveguide and the input side second waveguide,
one of first ground electrodes that is arranged in parallel with the input side first waveguide, and
the other of the ground electrodes that is arranged in parallel with the input side second waveguide, and
the second electrode is an electrode having a coplanar structure that includes
a second signal electrode that is arranged in parallel with a portion between the output side first waveguide and the output side second waveguide,
one of second ground electrodes that is arranged in parallel with the output side first waveguide, and
the other of the second ground electrodes that is arranged in parallel with the output side second waveguide.

10. The optical device according to claim 1, wherein a material having the electro-optical effect includes a material in which γ 33 is equal to or greater than 25 pm/V.

11. The optical device according to claim 1, wherein a material of the substrate includes at least one of materials made of Si, SiO₂, Qtz, and sapphire.

12. The optical device according to claim 1, wherein a material of the optical waveguide includes at least one of materials made of Si, SiN, and LN.

13. The optical device according to claim 1, wherein a material of the first electrode includes at least one of materials made of Au, Al, and Cu.

14. The optical device according to claim 1, wherein a chip width of the first chip is equal to or less than 300 μm.

15. An optical transmitter comprising an optical modulator element that modulates light guided in accordance with an electrical signal, wherein
the optical modulator element includes
a substrate;
an optical waveguide that is provided on the substrate; and
a first chip and a second chip each of which is mounted on the substrate, includes a material having an electro-optical effect that is higher than that of the substrate, and includes a crystal axis in which the strongest electro-optical effect is exerted,
the optical waveguide includes
a first coupler,
an input side first waveguide and an input side second waveguide that are connected to the first coupler,
a second coupler,
an output side first waveguide and an output side second waveguide that are connected to the second coupler,
a first bent waveguide that connects a portion between the input side first waveguide and the output side first waveguide, and
a second bent waveguide that connects a portion between the input side second waveguide and the output side second waveguide,
the first chip includes
a first electrode that is arranged in the vicinity of the input side first waveguide, and that applies an electric field flowing in the same direction with respect to an orientation of the crystal axis of the first chip to the input side first waveguide, and
the second chip includes
a second electrode that is arranged in the vicinity of the output side first waveguide, and that applies an electric field flowing in the same direction with respect to an orientation of the crystal axis of the second chip to the output side first waveguide.

16. An optical transceiver comprising:
an optical modulator element that modulates light guided in accordance with an electrical signal;
an optical receiver element that converts received signal light to an electrical signal; and
a signal processing unit that generates an electrical signal to be output to the optical modulator element, and that processes the electrical signal obtained from the optical receiver element, wherein
the optical modulator element includes
a substrate;
an optical waveguide that is provided on the substrate; and
a first chip and a second chip each of which is mounted on the substrate, includes a material having an electro-optical effect that is higher than that of the substrate, and includes a crystal axis in which the strongest electro-optical effect is exerted,
the optical waveguide includes
a first coupler,
an input side first waveguide and an input side second waveguide that are connected to the first coupler,
a second coupler,
an output side first waveguide and an output side second waveguide that are connected to the second coupler,
a first bent waveguide that connects a portion between the input side first waveguide and the output side first waveguide, and
a second bent waveguide that connects a portion between the input side second waveguide and the output side second waveguide,
the first chip includes
a first electrode that is arranged in the vicinity of the input side first waveguide, and that applies an electric field flowing in the same direction with respect to an orientation of the crystal axis of the first chip to the input side first waveguide, and
the second chip includes
a second electrode that is arranged in the vicinity of the output side first waveguide, and that applies an electric field flowing in the same direction with respect to an orientation of the crystal axis of the second chip to the output side first waveguide.
